(19) United States
(12) Patent Application Publication
(10) Pub. No.: US 2026/0222908 A1
(43) Pub. Date: Jul. 30, 2026

(54) METHODS AND SYSTEMS FOR PREDICTIVE SIGNAL BLOCKAGE DETECTION

(71) Applicant: Huawei Technologies Co., Ltd., Shenzhen (CN)

(72) Inventors: Remziye Irem Bor Yaliniz, Ottawa (CA); Nimal Gamini Senarath, Ottawa (CA)

(21) Appl. No.: 19/629,606

(22) Filed: Mar. 26, 2026

Related U.S. Application Data
(63) Continuation of application No. PCT/CN2024/091228, filed on May 6, 2024.
(60) Provisional application No. 63/586,817, filed on Sep. 29, 2023.

(51) Int. Cl. H04W 28/02; H04W 28/08

(52) U.S. Cl. CPC H04W 28/0284; H04W 28/0226; H04W 28/0942

(57) ABSTRACT

A method and system of predictive signal blockage detection using digital replicates of communication networks is provided. The method includes receiving a request for predictive blockage detection (PBD) within a vulnerability region covered by the wireless network, a predictive blockage detection being indicative of a future signal degradation in the vulnerability region. The method further includes retrieving entity data associated with one or more digital representatives (D-Reps), the one or more D-Reps corresponding to digital replicates of real-world entities, the entity data comprising real-world data collected from the real-world entities. The method also includes performing the predictive blockage detection based on retrieved entity data, and transmitting a blockage alert when a blockage is predicted.

### CROSS-REFERENCE TO RELATED APPLICATIONS

This application is a continuation of International Patent Application No. PCT/CN2024/091228, filed on May 6, 2024, which claims the benefits of U.S. Provisional Ser. No. 63/586,817 , filed on Sep. 29, 2023, and titled “Methods and Systems for Predictive Blockage Detection,” the disclosures of which are hereby incorporated by reference in their entireties.

### TECHNICAL FIELD

The technical field generally relates to blockage detection in communication networks, and more specifically to methods and systems for predicting communication or signal blockages using digital replicates of communication networks.

### BACKGROUND

Digital communications between two or more digital devices, with or without user intervention, have become a staple of modern life. As digital communications become more sensitive, by their nature or by the communication channels used, sources of blockage can be problematic in maintaining reliability. There exist methods for manipulating communication channels when blockages are detected, such performing calculations regarding channel and beam power to perform beam sweeping when blockage is detected. Such methods are usually performed at a single node of the network, a base station, for instance, when blockage is detected at the base station. Other methods exist for detecting potential blockage, such as using an RF based method to predict blockage at a physical location on the network.

However, the methods mentioned above are localized methods that do not allow for a scalable way to predict blockage throughout a given network, as they are centralized methods. Therefore, there is a need for methods and systems capable of overcoming at least some of the shortcomings of the known methods.

### SUMMARY

The method and system for predictive blockage detection of communication signals described herein advantageously provide inter-operability, efficient access and utilization of vast amounts of data and the ability to derive timely and accurate predictions and solutions. The method and system, by performing predictive blockage detection, allow for improving communication reliability, namely by providing resolution mechanisms to predicted blockage.

In an aspect, a method of predicting a signal blockage within a wireless network is provided. The method includes receiving a request for predictive blockage detection (PBD) within a vulnerability region covered by the wireless network, a predictive blockage detection being indicative of a future signal degradation in the vulnerability region. The method further includes retrieving entity data associated with one or more digital representatives (D-Reps), the one or more D-Reps corresponding to digital replicates of real-world entities, the entity data comprising real-world data collected from the real-world entities. The method further includes performing the predictive blockage detection based on retrieved entity data, and transmitting a blockage alert when a blockage is predicted.

In some embodiments, the request for predictive blockage detection is transmitted by a first D-Rep, and the vulnerability region is a geographical region in which a first entity associated with the first D-Rep is located or moving towards. Further, the one or more D-Reps correspond to digital replicates of real-world entities and the entity data can include real-world data collected from the real-world entities. The alert can be transmitted to one of said first D-Rep and said first entity when a predicted signal blockage is detected.

In some embodiments, the vulnerability region includes vulnerable network entities, and transmitting the blockage alert comprises transmitting the blockage alert to D-Reps associated with the vulnerable network entities.

In some embodiments, the method further includes generating a risk map of an area including a plurality of vulnerability regions. A given vulnerability region of the risk map is updated when an associated predictive blockage detection performed.

In some embodiments, each of the vulnerability regions has a periodicity, and a respective request for PBD is periodically triggered for each of the vulnerability regions based on the periodicity.

In some embodiments, updating the given vulnerability region comprises determining a blockage risk based on performing the PBD in the vulnerability region. In some embodiments, the blockage risk is further determined based on available physical resources within the vulnerability region.

In some embodiments, the available physical resources include channel frequency, channel capacity, bandwidth, resource blocks, antenna capability and sensing data availability.

In some embodiments, the request for PBD includes PBD parameters with a list of D-Reps located in the vulnerability region, and retrieving the entity data comprises connecting with nodes of the network hosting the D-Reps located in the vulnerability region based on the PDB parameters.

In some embodiments, the method further includes generating a resolution mechanism to be performed by a target network entity to prevent blockage, when a blockage is predicted. The resolution mechanism can be selected from a group including an antenna handover, a signal frequency change, a beamforming update, and a repositioning of the target network entity.

In some embodiments, performing the predictive blockage detection comprises predicting future locations of the real-world entities associated with the one or more D-Reps and determining whether an obstructing network entity is predicted to obstruct a signal on the network at one of the future locations.

In some embodiments, transmitting the blockage alert comprises transmitting the blockage alert to a plurality of D-Reps located within the vulnerability region.

In some embodiments, transmitting the blockage alert comprises transmitting the blockage alert to a plurality of the real-world entities located within the vulnerability region.

In some embodiments, transmitting the blockage alert includes transmitting an alert time window indicative of blockage duration.

In another aspect, an apparatus for predicting a signal blockage within a wireless network is provided. The apparatus includes an analysis module adapted to receive a request for predictive blockage detection (PBD) within a vulnerability region covered by the wireless network, wherein a predictive blockage detection is indicative of a future signal degradation in the vulnerability region. The analysis module is further adapted to perform the predictive blockage detection based on retrieved entity data, and to transmit a blockage alert when a blockage is predicted. The apparatus also includes a data collection module adapted to retrieve the entity data associated with one or more digital representatives (D-Reps), the one or more D-Reps corresponding to digital replicates of real-world entities, and the entity data comprising real-world data collected from the real-world entities.

In another aspect, a computer-readable medium is provided. The computer-readable medium includes computer-readable instructions that, when executed by one or more processors, perform any method described herein.

In another aspect, a device is provided. The device includes a memory storing computer-readable instructions, and one or more processors configured, by executing the instructions, to perform any method described herein.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1 shows an example communication system that can be used in conjunction with one or more embodiments.

FIG. 2 shows an example of the interconnections between base stations and other elements of a communication system.

FIG. 3 shows an example schematic representation of an electronic device, a terrestrial base station, and a non-terrestrial base station of a communication system.

FIG. 4 shows a block diagram of the modules of an electronic device according to an embodiment.

FIG. 5 shows a 6G system conceptual structure according to an embodiment.

FIG. 6 shows a representation of function elements and internal interfaces of a connectivity service (NET4CON) according to an embodiment.

FIG. 7 shows example external interfaces of the NET4CON service of FIG. 6.

FIG. 8 shows additional example external interfaces of the NET4CON service of FIG. 6.

FIG. 9 shows a process for performing predictive blockage detection according to an embodiment.

FIG. 10 shows a scenario where a predictive blockage detection is used to predict blockage generated by a vehicle according to an embodiment.

FIG. 11 shows a flowchart of data exchange between the elements of a D-Net when predicting blockage using predictive blockage detection according to an embodiment.

FIG. 12 shows a flowchart of a PBD Alarm and Resolution procedure according to an embodiment.

FIG. 13 is a block diagram of an example computing system that may be used in conjunction with one or more embodiments.

### DETAILED DESCRIPTION OF THE ILLUSTRATIVE EMBODIMENTS

In the following description and figures, same reference numbers refer to similar elements of the present disclosure. Furthermore, to not unduly clutter the figures, it is possible that a figure may not contain all the reference numbers of the elements found in the figure. It is also possible that some elements or components may be referenced in only one figure. The element thereby referenced can easily be inferred in the other figures shown. The embodiments, geometrical configurations, materials and/or dimensions shown in the figures or described in the present disclosure are only indicative, and show possible embodiments, presented as examples, and should not be interpreted as limitations of the present disclosure.

Generally, described is a Predictive Blockage Detection (PBD) method and system, for predicting potential blockage in a network and/or an area. The method and system may use Digital Representatives (D-Reps) of real-world objects, or entities, to predict potential performance loss within a wireless network. The method and system described herein can advantageously allow for inter-operability, efficient access, and utilization of vast amounts of data and ability to derive timely and accurate blockage predictions and solutions.

In the following description, a Digital World (DW) instance can represent a replicate of a Real World (RW) instance. For example, an RW infrastructure, such as a factory, can be represented as a DW instance in a network, where the DW instance is created, or generated, and maintained by collecting real-time, granular data from the factory. The DW instance generally mimics the RW instance accurately, depending on real-world data collected, such that it allows for “what-if” simulations or predictions, proactive maintenance, and precise optimizations, for example. A DW instance can include a plurality of Digital Representatives (D-Rep), which are digital replicates of real-world entities or objects. For example, a driverless car or a robot in a factory that can be represented by a D-Rep and used as elements of the DW instance. Based on the purpose or type of DW instance, a given DW instance can include several different functionalities. For example, a Digital Infrastructure (D-Inf) is a DW instance of an infrastructure, such as a factory or a city, a Digital Robotics (D-Robo) is a DW of a factory, a car, or any environment that includes robots and automation, and a Digital Network (D-Net) is a DW instance of a wireless communication network. As will be described in more detail below, a D-Net includes one or more D-Reps of wireless network elements, that can include, without being limited to, user equipment (UE), Wireless channel grids, and Base stations (BS) at all tiers, including mobile or moving BSs and Satellites.

In the context of the present disclosure, the term ‘user equipment’, or ‘UE’, may represent a combination of a network access device (NAD) and a user personal device (UPD). It may also refer to the person who uses the UE.

The method and system described herein can allow for predicting blockage or partial blockage of communication channels/signals by performing predictions using D-Reps of a D-Net. The method and system can advantageously allow for predicting, for example based on the current or future location of various objects as represented by their respective D-Reps, whether a given communication signal or region may be blocked. For instance, in millimeter Wave (mmWave) and Terahertz (THz) applications, non-stationarity of signals that are prone to blockage, such as blockage due to the mobility of UEs, and mobility of the obstructing entities, including vehicles, can cause issues to communications. Therefore, predicting such blockages can allow for reducing performance loss.

In some embodiments, the D-Net may not be the sole collector of information nor the sole conductor of analysis. The D-Net can synthesize and collect analyses performed by a number of D-Reps or modules. For example, the D-Net can collect analyses performed by a D-City. In one embodiment, the D-Net is responsible for creating the environment, including communication, alerting, and data collection means, for conducting analysis and predictions. For instance, a D-Inf/D-Robo may predict blockage due to mobility of a truck and alert the D-Rep of a UE, a BS, or a region. Analyses and predictions can therefore be conducted in a distributed fashion. D-Reps of said UE, BS, or region can conduct further analysis to validate the prediction and determine actions in response to the predictions, for instance.

Therefore, the D-Net can advantageously allow for providing a centralized controller capable of distributed learning and of distributing the features among entities. Further, the D-Net may not be an offline simulator, and predictions and analyses can be meta-results of many online analysis. Some embodiments of the method and system described herein advantageously allow for using D-Reps to improve or optimize wireless networks, and proactively maintain communication quality. Further, the method and system can utilize D-Reps to predict potential performance loss. For instance, high demand in wireless data rate, low latency, and reliability objectives can be improved by detecting future physical blockage. As mentioned, the method and system advantageously allow for inter-operability, efficient access and utilization of vast amounts of data, and ability to derive timely and accurate solutions and predictions.

As will be described in more detail below, the D-Net can utilize D-Reps to predict blockage and trigger one or more preventative mechanisms such as an antenna handover, a frequency change, a beamforming update, or a user-in-the-loop action, for instance. In one embodiment, the predictive blockage detection can be performed based on a geographical region, based on a specific UE, or on a hybrid basis, with each defining or having vulnerable users and potential blockages. For instance, a truck, represented as a D-UE or as a D-Inf in some embodiments, can be labelled as a potential blockage when it is predicted that the truck will go through a given area. Similarly, a UE that has critical communication requirements, such as with mmWave applications, can be labelled as a vulnerable UE when performing predictive blockage detection. In some embodiments, a building that a vulnerable UE is moving towards can also be labelled as a potential stationary blockage, for instance.

In one embodiment, blockage probability is evaluated for a period of time, such as for T seconds. Further, blockage risk associated with a particular region, grid and/or UE may be updated periodically and/or upon alarms. For instance, upon predicting potential or future blockage created by a truck moving through an area, where the truck will cause interruption or significant change to the communication channel of a user due to their relative mobility, an alarm can be generated and shared with alarm subscribers, such as all D-Reps located in the given area. Alternatively, the alarm can be sent to associated entities. These entities can be RW or DW entities.

Resolution options or mechanisms in response to the detection of a predicted blockage can vary depending on the scenario in which the prediction and the alarm are generated. For instance, upon detecting that a UE will move into a blocking or blockage area, a user can be notified and informed to move to a less risky position (user-in-the-loop resolution). Alternatively, or in addition, the beamforming matrix of antennas can be updated, such as for reconfigurable intelligent surface (RIS) and multiple input/multiple output (MIMO), to reduce the risk of blockage. Other resolution mechanisms include caching content before a blockage occurs or performing an antenna handover, for instance. The accuracy of the resolution mainly relies on the accuracy/freshness of the collected information and the prediction algorithms. The resolution mechanisms or options can be taken not only by network elements, such as base stations, but also by the affected entities such as the blockage source or the vulnerable entity.

Embodiments of the present application can be implemented as part of an operating environment including various systems, components, modules, as further described below.

### Example Operating Environment

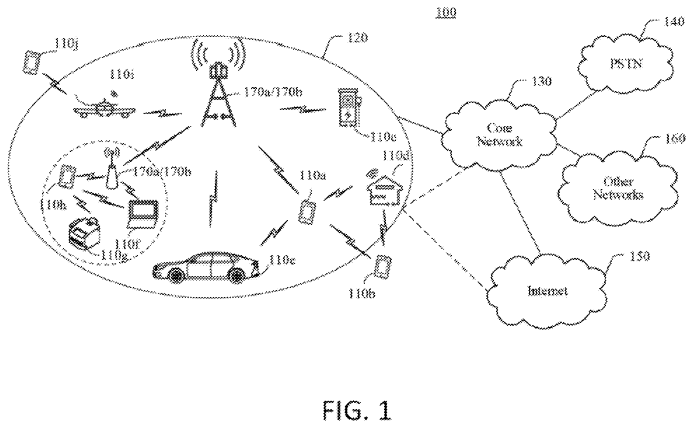

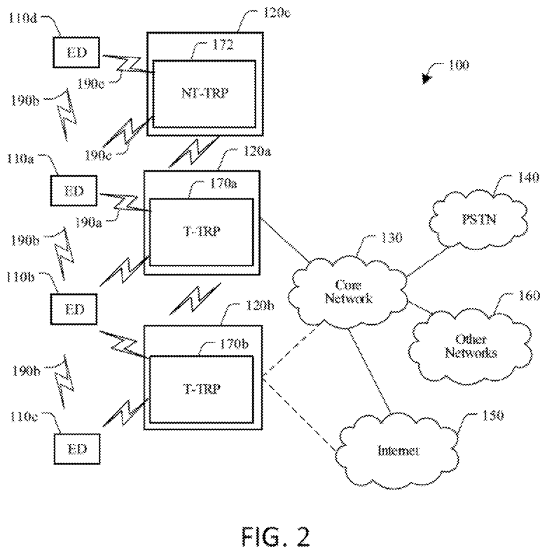

Referring to the embodiments shown in FIGS. 1 and 2, a schematic illustration of a communication system 100 is provided. The radio access network (RAN) 120 may be a next generation (e.g. 6th generation (6G) or later) radio access network, or a legacy (e.g. 5th generation (5G), 4th generation (4G), 3th generation (3G) or 2nd generation (2G)) radio access network. In some implementations, 6G radio access refers to the next generation air interface of standards which may comprise both terrestrial networks (TNs) and non-terrestrial networks (NTNs). One or more communication electronic devices (ED) 110a, 110b, 110c, 110d, 110e, 110f, 110g, 110h, 110i, 110j, generically referred to as 110, can be interconnected to one another or connected to one or more network nodes 170a, 170b, generically referred to as 170, in the radio access network 120. A core network 130 can be a part of the communication system and can be dependent or independent of the radio access technology used in the communication system 100. Further, the communication system 100 comprises a public switched telephone network (PSTN) 140, the internet 150, and other networks 160. In other embodiments, the communication system 100 can comprise fewer or more elements.

In general, the communication system 100 enables multiple wireless or wired elements to communicate data and other content. The communication system 100 may provide content, such as voice, data, video, and/or text, via broadcast, multicast, groupcast, unicast, etc. The communication system 100 may provide a wide range of communication services and applications including enhanced Mobile Broadband (eMBB) services, ultra-reliable low-latency communication (URLLC) services, massive machine type communication (mMTC) services, integrated sensing and communication (ISAC), immersive communication, massive communication, Hyper reliable and low-latency communication, ubiquitous connectivity, integrated AI and communication and other services that can be provide by the future generation communication system. The communication system 100 may provide other services/applications such as earth monitoring, remote sensing, passive sensing and positioning, navigation and tracking, autonomous delivery and mobility, etc.

The communication system 100 may operate by sharing resources, such as carrier spectrum bandwidth, among its constituent elements.

The communication system 100 may include a terrestrial communication system and/or a non-terrestrial communication system. The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system.

The electronic device 110 is used to connect persons, objects, machines, etc. The electronic device 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each electronic device 110 represents any suitable end user device for wireless operation and may include such devices (or may be referred to but not limited to) as a user equipment (UE) or a user device or a terminal, a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation electronic devices 110 may be referred to using other terms.

Network node 170 may be a base station. A base station is a network element in radio access network responsible for radio transmission and reception in one or more cells to or from the user equipment. The base stations 170a-170b may be known by other names in some implementations, such as a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a positioning node, among other possibilities. The base stations 170a-170b may be a macro base station (BS), a pico BS, a relay node, a donor node, or the like, or combinations thereof.

With reference to FIG. 2, the communication system 100 enables multiple wireless or wired elements to communicate data and other content. The communication system 100 can provide content, such as voice, data, video, and/or text, via broadcast, multicast, groupcast, unicast, etc. The communication system 100 can operate by sharing resources, such as carrier spectrum bandwidth, between its constituent elements. The communication system 100 can include a terrestrial communication system and/or a non-terrestrial communication system and can provide a wide range of communication services and applications, such as earth monitoring, remote sensing, passive sensing and positioning, navigation and tracking, autonomous delivery and mobility, for example. The communication system 100 provides a high degree of availability and robustness through a joint operation of a terrestrial communication system and a non-terrestrial communication system. For example, integrating a non-terrestrial communication system, or the components thereof, into a terrestrial communication system can result in what may be considered a heterogeneous network comprising multiple layers. Compared to conventional communication networks, the heterogeneous network can achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d, referred to as ED 110, radio access networks (RANs) 120a, 120b, a non-terrestrial communication network 120c, a core network 130, a public switched telephone network (PSTN) 140, the Internet 150, and other networks 160. The RANs 120a, 120b include respective base stations (BSs) 170a, 170b, which can be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 can be alternatively or additionally configured to interface, access, or communicate with any T-TRP 170a, 170b and NT-TRP 172, the Internet 150, the core network 130, the PSTN 140, the other networks 160, or any combination of the preceding. In some embodiments, ED 110a can communicate an uplink and/or downlink transmission over a terrestrial air interface 190a with T-TRP 170a. Further, the EDs 110a, 110b, 110c, and 110d can also communicate directly with one another via one or more sidelink air interfaces 190b. In some embodiments, ED 110d can communicate an uplink and/or downlink transmission over a non-terrestrial air interface 190c with NT-TRP 172.

The air interfaces 190a and 190b can use similar communication technology, such as any suitable radio access technology. For example, the communication system 100 can implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA), also known as discrete Fourier transform spread OFDMA (DFT-s-OFDMA) in the air interfaces 190a and 190b. The air interfaces 190a and 190b can utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or a link. For instance, the link can be a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 can be in direct or indirect communication with one or more other RANs (not shown), which may or may not be directly served by core network 130, and may or may not employ the same radio access technology as RAN 120a, RAN 120b or both. The core network 130 can also serve as a gateway access between (i) the RANs 120a and 120b or EDs 110a 110b, and 110c or both, and (ii) other networks, such as the PSTN 140, the Internet 150, and the other networks 160. In addition, some or all of the EDs 110a 110b, and 110c can include functionality for communicating with different wireless networks over different wireless links using different wireless technologies and/or protocols. Instead of wireless communication (or in addition thereto), the EDs 110a 110b, and 110c can communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c can be multimode devices capable of operation according to multiple radio access technologies, and incorporate multiple transceivers necessary to support such.

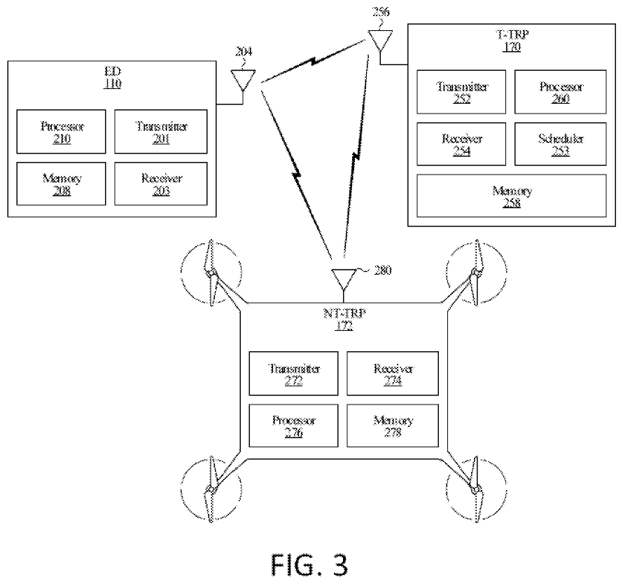

Turning to the embodiment shown in FIG. 3, an exemplary ED 110 and base station 170a, 170b and/or 170c are shown. The ED 110 is used to connect, through a network, persons, objects, or machines, for example. The ED 110 can be used in applications including cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, for example.

Each ED 110 represents any suitable end user device for wireless operation that can include a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an Internet-of-Things (IoT) device, wearable devices such as a watch, a pair of glasses, head mounted equipment, an industrial device, or an apparatus such as a communication module, modem, or chip comprising the forgoing devices, for example. It will be understood that future generation EDs 110 may be referred to using other terms. The base station 170a and 170b is a T-TRP, thereafter referred to as T-TRP 170. Each ED 110 connected to T-TRP 170 and/or NT-TRP 172 can be dynamically or semi-statically turned on, e.g., established, activated, or enabled, turned off, e.g., released, deactivated, or disabled, and/or configured in response to one of more of: connection availability and connection necessity.

The ED 110 includes a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 can be integrated as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208, such as a non-volatile computer-readable memory. The memory 208 stores computer-executable instructions and data used, generated, or collected by the ED 110. For example, the memory 208 can store computer-executable instructions or modules configured to implement some or all of the functionalities and/or embodiments described herein and that are executed by one or more processing unit(s) (e.g., a processor 210). Each memory 208 includes any suitable volatile and/or non-volatile storage and retrieval device(s). Any suitable type of memory can be used, such as random access memory (RAM), read only memory (ROM), hard disk, optical disc, subscriber identity module (SIM) card, memory stick, secure digital (SD) memory card, on-processor cache, for example.

The ED 110 can further include one or more input/output devices (not shown) or interfaces, such as a wired interface to the Internet 150 shown in FIG. 1. The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, or a touch screen.

The ED 110 includes processor 210 for performing operations including operations related to preparing a transmission for uplink transmission to the NT-TRP 172 and/or the T-TRP 170, such as operations related to processing downlink transmissions received from the NT-TRP 172 and/or the T-TRP 170, and operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. In some embodiments, a downlink transmission can be received by the receiver 203, using receive beamforming, and the processor 210 can extract signaling from the downlink transmission, such as by detecting and/or decoding the signaling. An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 can perform operations relating to network access, such as initial access, and/or downlink synchronization, such as operations relating to detecting a synchronization sequence, decoding and obtaining the system information. In some embodiments, the processor 210 can perform channel estimation, such as using a reference signal received from the NT-TRP 172 and/or from the T-TRP 170. Although not illustrated, in some embodiments, the processor 210 can form part of the transmitter 201 and/or part of the receiver 203. Furthermore, the memory 208 can form part of the processor 210.

The processor 210, the processing components of the transmitter 201, and the processing components of the receiver 203 can each be implemented by the same or different one or more processors that are configured to execute computer-executable instructions stored in a memory, such as in the memory 208. Alternatively, some or all of the processor 210, the processing components of the transmitter 201, and the processing components of the receiver 203 can each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

The T-TRP 170 can also be referred to as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), or a positioning node. Further, the T-TRP 170 can be a macro BS, a pico BS, a relay node, or a donor node, for example. The T-TRP 170 can alternatively refer to an apparatus, such as a communication module, a modem, or a chip.

In some embodiments, the parts of the T-TRP 170 can be distributed. For example, some of the modules of the T-TRP 170 may be located remote from the equipment that houses the antennas 256 for the T-TRP 170, and may be coupled to the equipment that houses the antennas 256 over a communication link (not shown), known as front haul, such as common public radio interface (CPRI). Therefore, in some embodiments, the term T-TRP 170 can also refer to modules on the network side that perform processing operations, such as determining the location of the ED 110, resource allocation and scheduling, message generation, and encoding/decoding, and that are not necessarily part of the equipment that houses the antennas 256 of the T-TRP 170. The modules can also be coupled to other T-TRPs. In some embodiments, the T-TRP 170 may actually be a plurality of T-TRPs that are operating together to serve the ED 110, through the use of coordinated multipoint transmissions, for instance.

The T-TRP 170 includes at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 can be integrated as a transceiver. The T-TRP 170 further includes a processor 260 for performing operations including preparing a transmission for downlink transmission to the ED 110, processing an uplink transmission received from the ED 110, preparing a transmission for backhaul transmission to the NT-TRP 172, and processing a transmission received over backhaul from the NT-TRP 172. Processing operations related to preparing a transmission for downlink or backhaul transmission can include operations such as encoding, modulating, precoding, multiple input multiple output (MIMO) precoding, transmit beamforming, and generating symbols for transmission. Processing operations related to processing received transmissions in the uplink or over backhaul may include operations such as receive beamforming, demodulating received symbols, and decoding received symbols. The processor 260 can also perform operations relating to network access, such as initial access, or downlink synchronization, such as generating the content of synchronization signal blocks (SSBs) and generating the system information. In some embodiments, the processor 260 also generates an indication of beam direction (e.g., BAI), which may be scheduled for transmission by a scheduler 253. The processor 260 performs other network-side processing operations described herein, such as determining the location of the ED 110 and determining where to deploy the NT-TRP 172. In some embodiments, the processor 260 may generate signaling, such as to configure one or more parameters of the ED 110 and/or one or more parameters of the NT-TRP 172. Any signaling generated by the processor 260 is sent by the transmitter 252. Note that “signaling”, as used herein, may alternatively be called control signaling. Signaling may be transmitted in a physical layer control channel, such as a physical downlink control channel (PDCCH), in which case the signaling may be known as dynamic signaling. Signaling transmitted in a downlink physical layer control channel may be known as Downlink Control Information (DCI). Signaling transmitted in an uplink physical layer control channel may be known as Uplink Control Information (UCI). Signaling transmitted in a sidelink physical layer control channel may be known as Sidelink Control Information (SCI). Signaling may be included in a higher-layer (e.g., higher than physical layer) packet transmitted in a physical layer data channel, e.g. in a physical downlink shared channel (PDSCH), in which case the signaling may be known as higher-layer signaling, static signaling, or semi-static signaling. Higher-layer signaling may also refer to Radio Resource Control (RRC) protocol signaling or Media Access Control-Control Element (MAC-CE) signaling.

In some embodiments, the scheduler 253 is coupled to the processor 260. Alternatively, the scheduler 253 can be included within or operated separately from the T-TRP 170. The scheduler 253 can schedule uplink, downlink, sidelink, and/or backhaul transmissions, including issuing scheduling grants and/or configuring scheduling-free, or configured grant, resources. The T-TRP 170 further includes a memory 258 for storing information and data. The memory 258 stores computer-executable instructions and data used, generated, or collected by the T-TRP 170. For example, the memory 258 can store computer-executable software instructions or modules configured to implement some or all of the functionality and/or embodiments described herein, when executed by the processor 260. Although not illustrated, the processor 260 can form part of the transmitter 252 and/or part of the receiver 254. Further, the processor 260 can implement the scheduler 253. The memory 258 can form part of the processor 260.

The processor 260, the scheduler 253, the processing components of the transmitter 252, and the processing components of the receiver 254 may each be implemented by the same or different one or more processors that are configured to execute computer-readable instructions stored in a memory, such as in the memory 258. Alternatively, some or all of the processor 260, the scheduler 253, the processing components of the transmitter 252, and the processing components of the receiver 254 may be implemented using dedicated circuitry, such as a programmed FPGA, a hardware accelerator, such as a GPU or AI accelerator, or an ASIC.

Although the NT-TRP 172 is illustrated as a drone in FIG. 3, the NT-TRP 172 can be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated to avoid congestion in the drawing. One, some, or all of the antennas may alternatively be panels. The transmitter 272 and the receiver 274 may be integrated as a transceiver. The NT-TRP 172 further includes a processor 276 for performing operations including preparing a transmission for downlink transmission to the ED 110, processing an uplink transmission received from the ED 110, preparing a transmission for backhaul transmission to T-TRP 170, and processing a transmission received over backhaul from the T-TRP 170, for instance. Processing operations related to preparing a transmission for downlink or backhaul transmission can include operations such as encoding, modulating, precoding, such as MIMO precoding, transmit beamforming, and generating symbols for transmission. Processing operations related to processing received transmissions in the uplink or over backhaul can include operations such as receive beamforming, demodulating received symbols, and decoding received symbols. In some embodiments, the processor 276 implements the transmit beamforming and/or receive beamforming based on beam direction information, such as BAI, received from the T-TRP 170. In some embodiments, the processor 276 may generate signaling to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information, such as computer-executable instructions, and data. Although not illustrated, the processor 276 may form part of the transmitter 272 and/or part of the receiver 274. Although not illustrated, the memory 278 may form part of the processor 276.

The processor 276, the processing components of the transmitter 272, and the processing components of the receiver 274 may each be implemented by the same or different one or more processors that are configured to execute computer-executable instructions stored in a memory, such as in the memory 278. Alternatively, some or all of the processor 276, the processing components of the transmitter 272, and the processing components of the receiver 274 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions. The T-TRP 170, the NT-TRP 172, and/or the ED 110 may include other components, but these have been omitted for the sake of clarity.

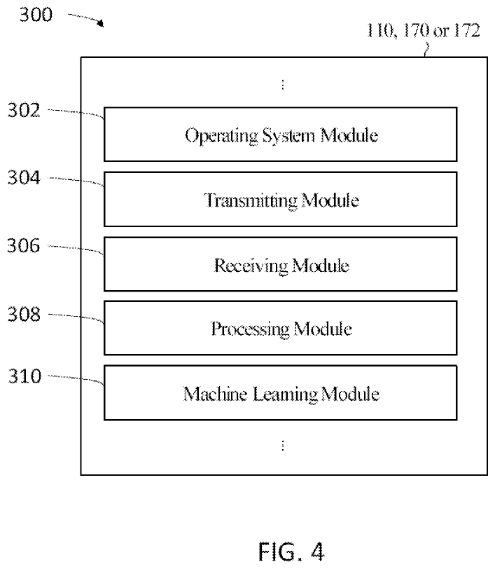

Turning to the embodiment of a detailed ED 300 shown in FIG. 4, one or more steps of the embodiment methods provided herein can be performed by corresponding units or modules included in the ED 110, in the T-TRP 170, or in the NT-TRP 172, which can include an Operating System module 302 to control the ED 110, the T-TRP 170, or the NT-TRP 172. A signal can be transmitted by a transmitting unit or by a transmitting module 304. A signal can be received by a receiving unit or by a receiving module 306. A signal can be processed by a processing unit or a processing module 308. Further, other steps can be performed by an artificial intelligence (AI) or machine learning (ML) module 310, for example. The respective units or modules of FIG. 4 can be implemented using hardware, one or more components or devices that execute software, or a combination thereof. For instance, one or more of the units or modules can be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by computer-executable instructions executed by a processor. It will be appreciated that where the modules are implemented using software including computer-executable instructions for execution by a processor for example, the modules may be retrieved by a processor, in whole or part as needed, individually or together for processing, in single or multiple instances, and that the modules themselves may include instructions for further deployment and instantiation. Additional details regarding the EDs 110, the T-TRP 170, and the NT-TRP 172 are known to those of skill in the art. As such, these details are omitted here.

The embodiments described in the present application are applicable to a next generation network, such as an exemplary sixth generation (6G) network described below, or a legacy network, such as 5G, 4G, 3G or 2G networks.

### Example 6G Network

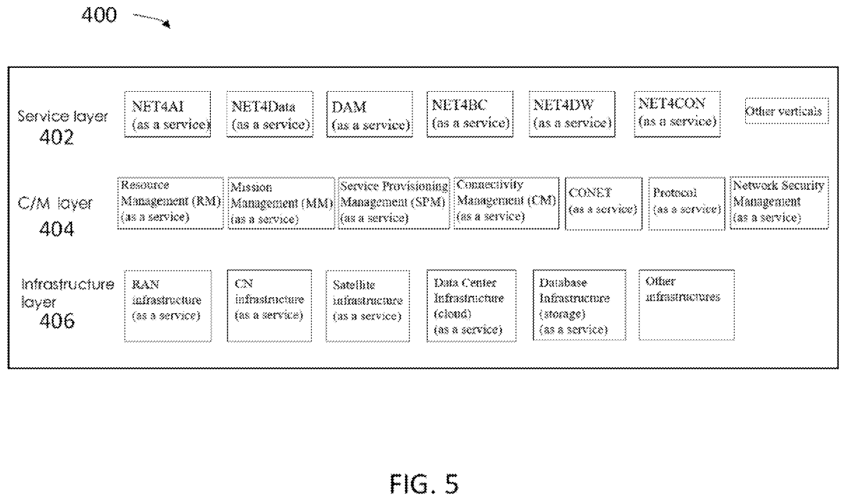

The proposed 6G System architecture is defined to support 6G Anything-as-a-service (XaaS) services by using techniques such as Network Function Virtualization and Network Slicing. The 6G System leverages a service-based architecture and the XaaS concept to utilize service-based interactions between 6G services. Turning to FIG. 5, XaaS services 400 in the 6G System are conceptually categorized, or structured, into three layers: a service layer 402, a control and management (C/M) layer 404, and an infrastructure layer 406. The infrastructure layer 406 includes infrastructures supporting 6G services, such as wireless networks (RAN, CN) infrastructures, Cloud/data center infrastructures, satellite networks, storage/database infrastructures, and sensing networks, for instance. These infrastructures can be provided by a single provider or by multiple providers. Each of the infrastructures may provide control and management functions (C/M functions), for infrastructure management. Each of these infrastructures is one type of infrastructure-as-a-service. The control and management (C/M) layer 404 include control and management services of the 6G System. The services are developed and deployed by using slicing techniques and utilizing resources provided by the infrastructure layer 406. 6G services in the C/M layer 404 include, without being limited to:
Resource Management (RM)-as-a-Service, providing a capability of life-cycle management of a variety of slices and over-the-air resource assignment to wireless devices,
Mission-as-a-Service, providing 6G mission services to be provided by a single 6G XaaS service or from multiple XaaS services,
Mission Management (MM)-as-a-Service, providing a capability to program provisioning of XaaS services at the Service layer 402 to provide mission services,
Confederation Network (CONET)-as-a-Service, providing a capability to enable multiple partners jointly provide 6G services-this capability is provided by confederation formation, mutual authentication, mutual authorization among partners and negotiation of agreement on recording and retracing of selected actions performed by partners, in order to assure a trustworthy environment of 6G System operations,
Service Provisioning Management (SPM)-as-a-Service, providing a capability of control and management of 6G service access by customers and provisioning of requested services-the capability is provided by unified mutual authentication, authorization and policy, key management, QoS assurance and charging between any pair of XaaS service provider and customer, where the customer can include real-world end-customers and D-Reps,
Connectivity Management (CM)-as-a-Service, leveraging 5G connectivity management functions with extensions to include the digital world,
Protocol-as-a-Service, providing a capability to design service customized protocol stacks for identified interfaces—the protocol stacks could be pre-defined for on-demand selection, or could be on-demand designed, and
Network Security-as-a-Service, providing a capability for owners of infrastructures to detect potential security risks of their infrastructures.

XaaS services of the C/M layer 404 support control and management of the 6G System itself and also provide support to verticals if requested. For instance, the RM-as-a-service can serve RAN for over-the-air resource management and can also provide services to a vertical for the vertical's over-the-air resource allocation to its end-customers. The XaaS in of the C/M layer 404 can be deployed by using slicing technique.

The Service layer 402 includes 6G services which provide services to customers. In the 6G System conceptual structure, an artificial intelligence (AI) service is denoted as NET4AI as a Service. The AI service provides AI capability to support a variety of AI applications. Services of data collection, data sanitization, data analysis and data delivery are denoted as DAM as a Service. The service provides a capability of lifecycle management of statistic data, including acquisition, de-privatization, analysis and delivery of data which are information statistic data from any types of sensors, devices, or network functions, for instance. Still referring to the service layer 402, a service of storage and sharing of data is denoted as NET4Data as a Service. The service provides a capability to trustworthily store and share data under the control of owners of data and following recognized authorities'regulations on control of identified data. A Service for providing a digital world is denoted as NET4DW as a Service. The digital world service provides a capability to construct, control and manage digital world. As mentioned above, a digital world instance is defined as digital realization, or replicate, of the physical world. The 6G network can further be adapted to provide a block chain service, denoted as NET4BC as a Service. Further, the service layer 402 provides an enhanced connectivity service, denoted as network for connectivity (NET4CON) as a service. This service provides a capability to support exchange of messages and data among new 6G services.

All XaaS services of the Service layer 402 are developed and deployed using resources provided by the infrastructure and utilizing Network Function Virtualization and Slicing techniques. The capability of each of 6G service is provided by its control and management functions and service specific data process functions. In order to support 6G XaaS services of the Service Layer 402, the 6G System leverages a 5G System for the provisioning of vertical services. The difference between 6G XaaS services and other verticals are that a vertical is a pure customer which needs other XaaS services to enable its operation, while each of XaaS services provide their capabilities to 6G customers. Any pair of XaaS services of the 6G System can also be mutual customer and provider to each other. For instance, an infrastructure owner can provide its resource to XaaS services in the Service layer 402 and the C/M layer 404. Alternatively, RM services may need the capabilities provided by NET4AI, DAM and NET4DW for resource management for vertical slicing. Still in other examples, a CONET service and a NET4Data service may need the capability provided by NET4BC for their operation.

Key concepts of the exemplary 6G System, or network, are discussed below:
Define Basic XaaS Services by decoupling comprehensive types of services into basic XaaS services. A basic XaaS service provides unique capability to enable a specific type of service, such as NET4AI service, NET4DW service, DAM service, NET4Data service, Block chain service, and mission management service,
Allow joint operation of the 6G System by multiple partners,
Define Data Plane of the 6G System which includes processing functions of data plane of XaaS services. Programing the interconnection of these functions, by mission management service, enables to support a variety of customized customer services,
Simplify 6G System architecture by categorizing basic control services and management services and combining them as basic XaaS services in the Control and Management (C/M) Layer,
Define C/M Plane of the 6G System which includes C/M functions in XaaS services and may include 5G CP (e.g., AMF) depending on implementation options,
Define Basic Architecture Structure (BAS) which is a unified basic structure with minimized number of interfaces and is independent of types of infrastructures,
Simplify standardization, development and deployment of the 6G System using the BAS concept, while supporting a variety of infrastructure deployment scenarios,
Adapt to a variety of deployment scenarios by applying the BAS or a subset of it to infrastructures based on capability, capacity and requirement of the infrastructure networks,
Leverage SBI interface concept and apply SBI interaction in both 6G C/M plane and 6G data plane,
Simplify SBI interfaces by introducing trustworthy gateways (GWs) through a Data Plane and a C/M Plane of the 6G System,
Improve trustworthiness from perspectives of operation of the 6G System by introducing CONET capability, NET4BC capability and anonymous service provisioning provided by the trustworthy GWs in the C/M plane and data plane of the 6G System,
Improve trustworthiness from perspective of end customer privacy protection by unified mutual authentication, IDM, data sanitization and etc. provided by SPM service, DAM service and 6G Block Chain service,
Simplify roaming management of wireless devices, in physical world and digital world, by unified authentication including all participated partners and customers,
multiple development paths from 5G System to 6G System by defining multiple architecture options without incurring much efforts due to the introduction of the BAS concept,
Support backward compatibility by utilizing benefits of SBA and its add-on feature. 5G users can use the 6G System to access 5G services,
Support future extension by adding new XaaS services with minimized impact on standardization and deployment, due to the introduced anonymous service provisioning concept implemented in trustworthy GWs in 6G C/M plane and in 6G data plane.

### NET4CON Service Framework

The NET4CON service of the Service layer 402 provides a plurality of functionalities that can be provided by an owners of infrastructures, such as a RAN provider or a CN provider, for instance. The NET4CON service is the owner of one or more gateways used to communicate with other services or elements in the network. For instance, the network can be defined and accessed through two communication planes, the control and management (C/M) plane and the data plane. Therefore, in an embodiment, a gateway, referred to as C/M-TW-GW, is provided for accessing the C/M plane, and another gateway, referred to as Data-TW-GW, is provided for accessing the data plane. The NET4CON service is the owner of the C/M-TW-GW and the Data-TW-GW. Through the ownership of the C/M-TW-GW and the Data-TW-GW, the NET4CON service provides a capability of anonymous interactions between XaaS services. The NET4CON service is further adapted to control and manage a BAS domain, infrastructure domain, or administration domain, and to enable 1) interactions between 6G XaaS services provided by same or different partners and 2) interactions between 6G XaaS services and verticals and XaaS services deployed in 3rd party infrastructures/clouds.

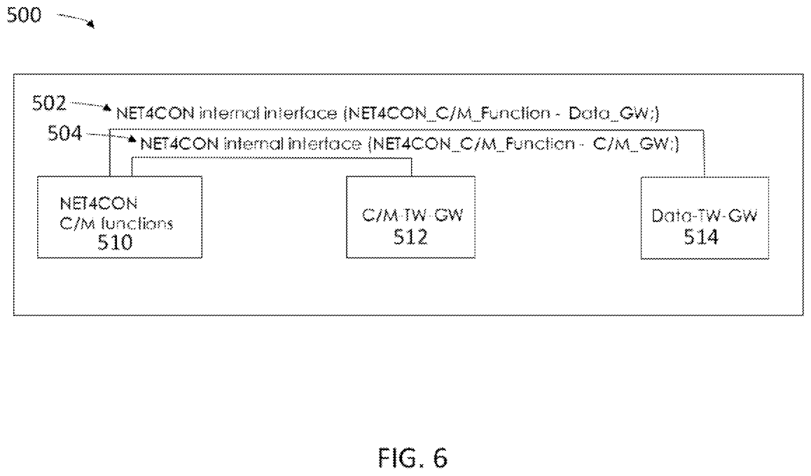

Turning to FIGS. 6-8, the NET4COM architecture 500, in one Basic Architecture Structure (BAS) domain or one administration domain, generally includes Logical Elements, internal interfaces, and external interfaces. The Logical Elements include NET4CON C/M functions 510, the C/M-TW-GW 512 and Data-TW-GW 514. The internal interfaces include a NET4CON_C/M_function—C/M-TW-GW 504, operatively connecting the NET4CON C/M functions with the C/M-TW-GW, and a NET4CON_C/M_Function—Data-TW-GW 502, operatively connection the NET4CON C/M functions with the Data-TW-GW.

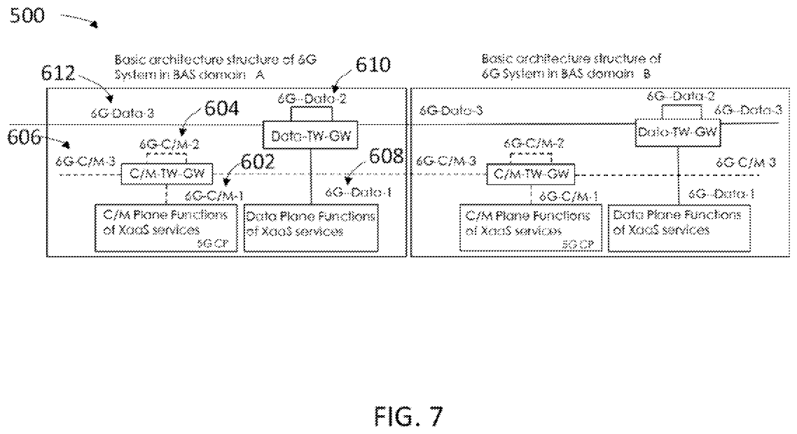

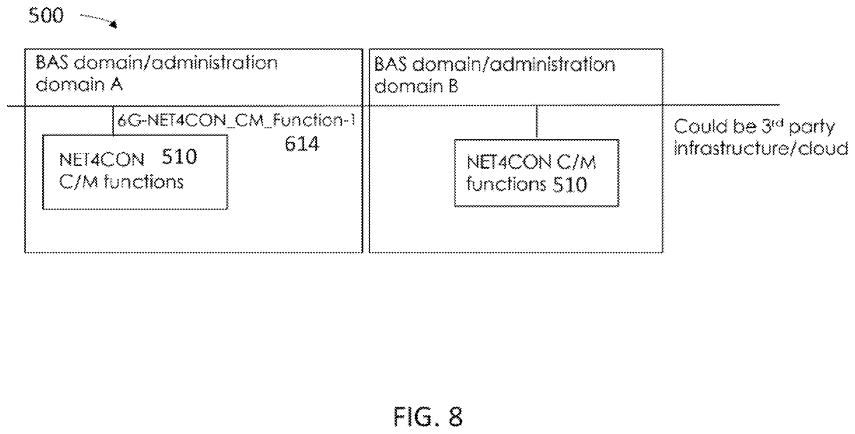

The External interfaces of the NET4CON architecture 500, better seen in FIGS. 7 and 8, generally enable exchanging data between the NET4CON and external elements. The External interfaces include 6G-C/M-1 602, 6G-C/M-2 604 and 6G-C/M-3 606 interfaces connecting with the C/M-TW-GW. The External interfaces further include 6G-Data-1 608, 6G-Data-2 610 and 6G-Data-3 612 interfaces connecting with the Data-TW-GW. The External interfaces also include NET4CON-NET4CON and External-NET4CON interfaces, for connecting with the NTE4CON C/M functions, and serving C/M-TW-GW and Data-TW-GW interfaces.

### NET4CON C/M Function

The NET4CON C/M function controls and manages the topology of Basic Architecture Structure (BAS) domain or infrastructure domain, including the logical connections between XaaS services and GWs deployed in the domain, and controls access of 6G devices, D-Users, or any type of customers, to the 6G system, or network, by managing the C/M session and the data session.

The NET4CON C/M function is further responsible for Information acquisition, which can include obtaining XaaS service deployment profile from external services, such as CONET and XaaS services, and obtaining XaaS service authorization profile. The NET4CON C/M function is further adapted to manage the BAS or administration domain logical topology, which includes, without being limited to:
Configuring GWs for setting up secured connections among these GWs, including 3rd parties' GWs,
Configuring C/M-TW-GWs and C/M plane functions of XaaS services in a BAS domain for setting up secured connections,
Configuring C/M-TW-GWs on service authorization of XaaS services and deployment of XaaS services,
Configuring C/M-TW-GWs and Verticals for setting up secured connection between the C/M-TW-GWs and verticals when needed,
Configuring Data-TW-GWs and data plane functions of XaaS services in a BAS domain for setting up secured connections, and
Configuring Data-TW-GWs and verticals for setting up secured connections between the Data-TW-GWs and verticals when needed.

The NET4CON C/M function also manages device C/M session and Data session for mobile devices and D-User (anchor) in the NET4DW. This includes controlling the establishment of device data session, which is the logical connection between a device and its serving Data-TW-GW. This also includes maintaining information for devices on their serving C/M session and Data session and mapping between RBs and sessions.

The NET4CON C/M is further adapted to manage log and load of the GWs. In one embodiment, the NET4CON C/M configures the C/M-TW-GWs and Data-TW-GWs on log of interactions of XaaS services on C/M plane and data plane. The NET4CON C/M also tracks load status of C/M-TW-GWs and Data-TW-GWs, and manages load balance of GWs by tearing down current secured connections of XaaS service functions from some of GWs and re-establish secured connections with other GWs.

### C/M-TW-GW

A C/M-TW-GW is adapted to provide capabilities to connect C/M plane functions of XaaS services and verticals in a Basic Architecture Structure domain (BAS) or infrastructure domain, in order to enable anonymous and secured C/M plane interaction among XaaS services, following authorization profiles of XaaS services. In an embodiment, the C/M-TW-GW function receives configuration from NET4CON C/M functions or other entities and maintains authorization profiles of XaaS services and manages local Active authorization table to control authorization for XaaS service consumers and providers. The C/M-TW-GW further receives configuration from NET4CON C/M functions or other entities and maintains deployment profiles of XaaS services, and also establishes and maintains one secured tunnel with each of XaaS services and verticals in a BAS or infrastructure domain. Other C/M-TW-GW functions include performing security tunnel related operations, performing Lawful C/M plane message inspection and message log, recording load of each of such tunnels to enable load management, and conducting multiple operation modes in procedures of C/M plane messages exchanges among XaaS services.

### Data-TW-GW

A Data-TW-GW provides capabilities to connect data plane functions of XaaS services and verticals in a Basic Architecture Structure domain (BAS) or infrastructure domain, to enable anonymous and secured data plane interaction among XaaS services and to manage assured service performance. The Data-TW-GW is adapted to perform a plurality of functionalities that can include:
Establishing and maintaining one secured tunnel with data plane function(s) of each of XaaS services and verticals in a BAS domain/infrastructure domain,
Receiving configuration for data packets exchange among XaaS services,
Recording load of each of such tunnels and updated to NET4CON C/M function to enable load management,
Performing decryption and encryption operation when transferring data packets in case needed,
Translating Data formats to enable XaaS service data plane function understand the format of data received,
Processing protocols for QoS and routing based on configuration by mission management or be carried in protocol stacks-the Data-TW-GW can process the protocol headers and performs corresponding QoS handling and routing operation,
Logging traffic, based on configuration, to support network operation optimization, service performance assurance and charging, and
Performing lawful inspection, under configuration.

### Internal Interfaces of NET4CON Service

As mentioned above, the NET4CON service can include NET4CON_C/M_Function—C/M_GW and NET4CON_C/M_Function—Data_GW interfaces. The NET4CON_C/M_Function—C/M_GW interface allows for the NET4CON C/M function to configure C/M-TW-GWs, including XaaS service deployment profiles and XaaS service authorization profiles, for instance. The interface also allows for the NET4CON C/M function to configure a C/M-TW-GW as a serving C/M-TW-GW of one device/D-user. The NET4CON_C/M_Function—C/M_GW interface further allows for the C/M-TW-GW to forward some C/M messages to NET4CON C/M function for decision making, such as serving C/M-TW-GW selection for a device. The interface also allows for the NET4CON C/M function to send its decision types of messages to C/M-TW-GW, and for the C/M-TW-GW to report its logged load information for load management by NET4CON C/M function.

The NET4CON_C/M_Function—Data_GW interface allows for the NET4CON C/M function to configure Data-TW-GWs, including XaaS service deployment profiles and XaaS service authorization profiles, for instance. The interface also allows for the NET4CON C/M function to configure a Data-TW-GW as a serving Data-TW-GW of one device/D-user. The interface further allows for the Data-TW-GW to report its logged load information for load management by NET4CON C/M function.

### External Interfaces of NET4CON Service

The external interfaces of NET4CON service, shown in FIG. 7, are interfaces between the NET4CON service and other XaaS services and functions implemented in 3rd party infrastructures.

The interface 6G-C/M-1 602 is used for receiving and sending C/M plane messages between a C/M-TW-GW and a C/M function of a XaaS service. The interface 602 further enables interactions between C/M functions of different XaaS services. The interface 6G-C/M-2 604 is used for interactions between C/M-TW-GWs within a BAS/infrastructure domain. The interface 6G-C/M-3 606 is used for interactions between C/M-TW-GWs belonging to different BAS or infrastructure domains. The interface 606 is further used for connecting the C/M-TW-GW with 3rd parties, the interface being used for interactions with the 3rd party's control and management functions, such as for information exposure.

### External Interfaces of Data-TW-GW

The interface 6G-Data-1 608 is used for receiving and sending data plane packets between a Data-TW-GW and a Data process function of a XaaS service. The interface 608 also enables data packet exchange between data process functions of different XaaS services. The interface 6G-Data-2 610 is used for interactions between Data-TW-GWs within a BAS or an infrastructure domain. The interface 6G-Data-3 612 is used for interactions between Data-TW-GWs belonging to different BAS or infrastructure domains. The interface 612 is further used for connecting with 3rd party networks or infrastructures, such as to provide interactions with 3rd party's data plane functions. For instance, the interface 612 can be used for sending data packets to 3rd parties'infrastructure or receiving data plane packets from 3rd parties'infrastructure.

### External Interfaces of NET4CON C/M Function

Turning to the embodiment shown in FIG. 8, a BAS or administration domain A can be connected with another BAS or administration domain B using interface 6G-NET4CON_C/M_Function-1 614. For instance, the interface 614 enables direct communication between NET4CON C/M functions between domains A and B. The interface 614 also enables direct communication between a BAS domain which has connection with 3rd parties' infrastructure and the control/management function of the 3rd parties. The interface 614 can be used for coordinating data plane processes and data packets exchange.

### Predictive Blockage Detection

The method and system described herein can be applicable, for example, to a 6G Digital World Scenario with an exemplary 6G network as described above. The digital World scenario can include Wireless network elements D-Reps, Infrastructure D-Reps, Factory D-Reps, Vehicle D-Reps, and Robotic D-Reps. For example, D-Reps can be digital representatives of users, base stations, intelligent surfaces, relays, drones, channels, antennas, buildings, bridges, smart city data, robots, production lines, cars, traffic elements, trucks, and robots.

Further, the method and system described herein can be implemented in a wireless network infrastructure, in a user equipment, in management or Operations, Administration and Management (OAM) elements, as well as in control and management (C/M) and data layer messaging.

A request for PBD may come automatically with some service requests, such as upon establishing URLLC communications that may require performing PBD as a quality/reliability measure. Therefore, receiving a request for the PBD may be restrictive. A vulnerability region may be determined once the PBD is performed, and may be one of the early outputs of the PBD.

In some embodiments, the request for PBD may be an initial trigger. The trigger may be an explicit request or a specific service, as mentioned above. After the trigger is received, data from the D-Reps and/or real-world objects is collected. The data is then processed based on a number of parameters from the service type to user mobility, and the PBD is performed. The algorithm or method used for performing the PBD may produce a vulnerability region, which may be specific to one user or shared by multiple users. One user may also be associated with a plurality of vulnerability regions, such as when different services have different signal strength requirements. The vulnerability region can thereafter be monitored and analyzed to detect blockage.

In the present description, a vulnerability region is intended to refer to a region in which risk of signal blockage may be mapped. The region may include only a proximal area of a single D-Rep or real-world entity, or may cover an entire geographical area, for instance. Once new PBDs are performed within a given vulnerability region, the vulnerability region may be updated to include new PBD results. Each vulnerability region may be divided into grids, to provide some granularity over the vulnerability region.

### Example PBD Method Initiation and Process

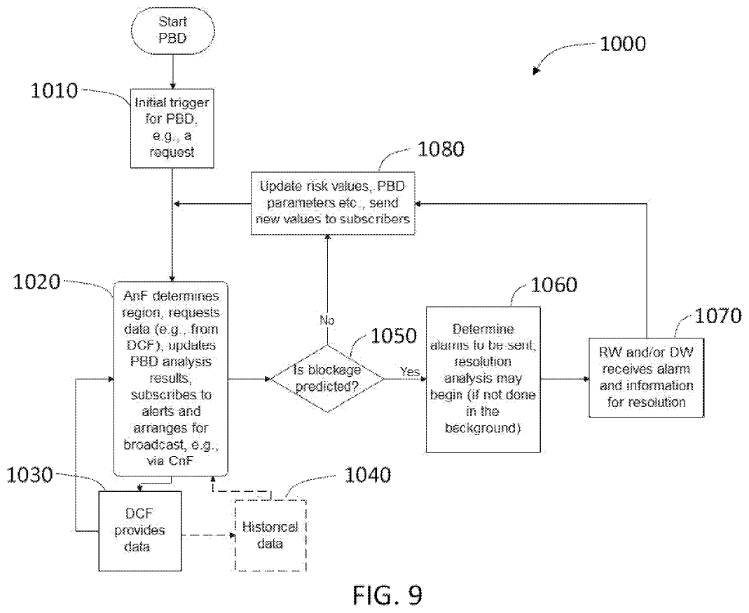

Turning to the embodiment shown in FIG. 9, the method 1000 for predictive blockage detection is based on establishing and collecting real-time or substantially real-time data traffic between D-Reps, such as D-Reps of a D-Inf, and optionally with D-UEs. At step 1010, the predictive blockage detection is started by an initial trigger. The trigger can be a manual request for performing blockage detection, such as a request manually sent by a real-world entity or a D-Rep. For instance, a UE or BS establishing a sensitive communication channel can send a trigger request to predict potential blockages. Sensitive communications can include URLLC or eMBB communications with high bandwidth requirements, mmWave, or 6 GHz and higher communications. The trigger can also be an automated request, such as a periodic request, a location-based request, or a time-related request, for instance. In some embodiments, the trigger can be based on a vulnerability region, such as 3D MIMO or RIS regions.

At step 1020, an Analysis Function (AnF) adapted to run a variety of simulations runs an initial analysis to determine the vulnerability region, PBD frequency, and begins generating a grid-based risk map, discussed in greater detail later. Performing the analysis may require data collected by D-Reps, and the method therefore includes, at step 1030, collecting the data via a data collection function (DCF). The data can include real-time or near real-time data, but may also include, at step 1040, retrieving historical data associated with one or more D-Reps. The AnF can subscribe to alerts also subscribed to by D-Reps and D-UEs, if needed. When the analysis is completed, the AnF determines whether blockage is predicted or not, at step 1050. When blockage is predicted, the AnF can generate alerts, at step 1060, based on the subscribed alerts. For instance, all D-Reps having subscribed to alerts in a vulnerability region may receive an alert when blockage is predicted in that vulnerability region. Alternatively, the alerts may be sent to all D-Reps or real-world entities located in the vulnerability region, or may be sent only to the triggering entity, such as a D-Rep of a UE or of a BS. The AnF may also generate resolution-related information for performing a resolution mechanism. When an alert is received, it can be received by several entities, such as D-Reps and D-UEs. Alerts can be treated differently based on their type. For example, when a high risk alert is generated, the alert can be sent to the physical entity for urgent scheduling update. When a medium risk alert is generated, the relevant D-Reps or the AnF can rerun the analysis and verify the validity of the alert. When a low risk alert is generated, the analysis can be rerun, verified, and resolved. For instance, at step 1070, once a D-Rep or a real-world entity receives an alarm, it may perform a resolution mechanism based on the alarm and resolution-related information received from the AnF.

In some embodiments, a risk map including a plurality of vulnerability regions is generated and updated using the analyses performed by the AnF. At step 1080, the risk map is updated based on the results from the PBD. Subscribers to alerts, such as D-Reps and D-UEs, may receive information on respective vulnerability regions when the risk map is updated, whether an alert is sent or not.

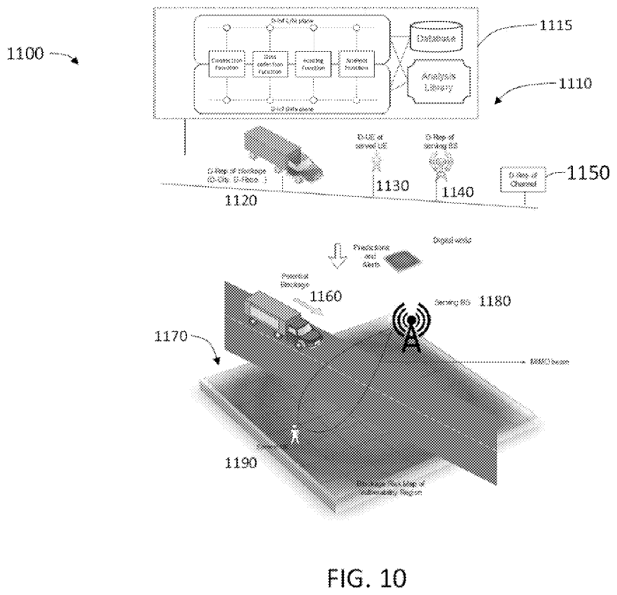

Turning to the embodiment shown in FIG. 10, an exemplary scenario 1100 includes a user equipment (UE) 1190 using a communication through a base station (BS) 1180. As the communication can be sensitive, the UE 1190 or the BS 1180, through their D-Reps 1130, 1140 or directly, triggers a predictive blockage detection that is carried out through a digital infrastructure (D-Inf) 1110. The D-inf includes both the D-Rep 1130 of the UE 1190 and the D-Rep 1140 of the BS 1180, and other D-Reps such as a D-Rep 1120 of a truck 1160 and a D-Rep 1150 of the communication channel, and framework functions 1115 for connecting the D-Reps, collecting data, and analyzing said data. Once the request is made, the PBD is triggered and the AnF runs the analysis on the vulnerability region 1170 surrounding the UE 1190 and the BS 1180. When the analysis is performed, the AnF can generate alerts that are broadcast to all D-Reps in the vulnerability region 1170. For example, using a D-Rep 1120 of a truck 1160 coming down the road, the AnF can detect, based on positioning data collected by the D-Rep 1120 and transmitted to the AnF, that the truck may disrupt a communication channel between the UE 1190 and the BS 1180. An alert can be generated and sent to the D-the AnF can be included in a digital infrastructure (D-Inf) 1110 that is operatively connected with associated D-Reps. In such a case, resolution mechanisms can include adapting the MIMO beam, or requesting the UE to move. In some embodiments, an alert can be sent to the D-Rep 1120 or directly to the truck 1160 for rerouting the truck and avoiding future disruption of the communication channel.

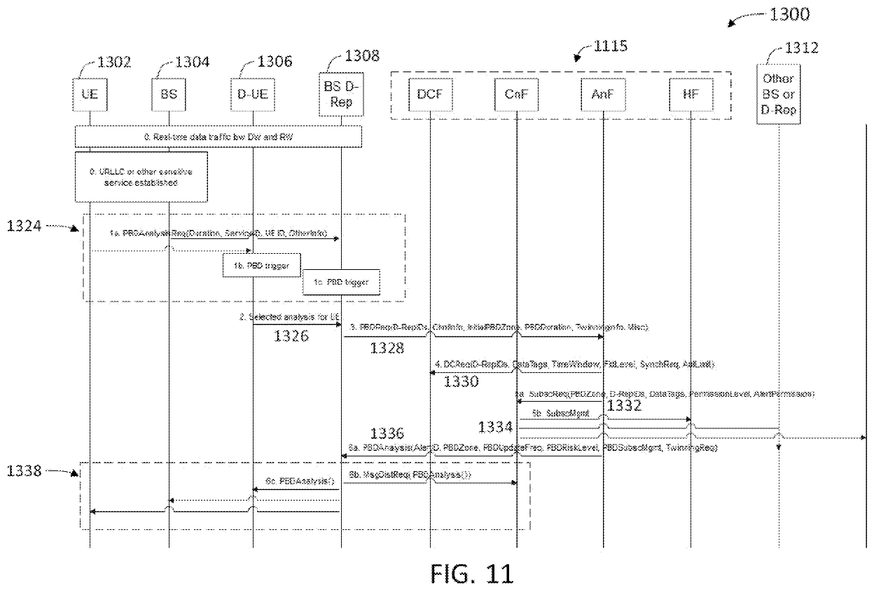

Turning to the embodiment shown in FIG. 11, data and message exchange 1300 between the various elements of the network is shown. In an embodiment, the D-Reps and D-UEs may collect real-time or near real-time data and the data generated from associated real-world entities or objects. For example, the UE 1302 and the BS 1304 generate real-time or near real-time data, and the data is collected by the D-UE 1306 and the BS D-Rep 1308. For instance, real-time data flow can exist between physical and digital entities such that fidelity and synch requirements are satisfied. Once a sensitive service is established, such as a URLLC service, the BS 1304 initiates a PBD 1324 from its D-Rep 1308. Alternatively, PBD may automatically begin based on one or more service requirements of the UE 1302, BS 1304 resources, such as 6 GHz blocks, or channel sensing condition and information. Further, the UE can trigger the PBD from its associated D-UE 1306. At step 1326, the D-Rep 1308 can subscribe to any additional information and analysis from the D-UE 1306. These analyses may include one or more of expected duration of the requested service, channel sensing information by the UE 1302 and predictions by the UE 1302, mobility prediction of the UE 1302 during the service, and precise location and predictions for future locations of the UE 1302.

At step 1328, the D-Rep 1308 sends a request to the network, such as to the D-Inf framework functions 1115 of the D-Inf 1110. In some embodiment, the framework functions 1115 are included in a D-Inf instance and comprise a connection function (CnF), a data collection function (DCF), a hosting function (HF), and an analysis function (AnF). The request can include a number of parameters (PBD parameters), such as D-Rep IDs, channel information, Initial PBD Zone, and PBD duration. D-Rep IDs are the Identifications (IDs) of any D-UEs that are involved in the communication, or surrounding D-Reps, for instance. The initial PBD zone can include grid IDs/numbers, geographical coordinates, service areas and similar as the zone/region descriptor, and the initial PBD zone can be used to define the vulnerability zone. PBD duration corresponds to the expected duration of the service or communication between the UE 1302 and the BS 1304. The PBD duration may be updated based on predictions. Other information, such as available synch level, available fidelity levels, mean age-of-information (AoI), max AoI, min AoI and other DW related metrics describing twinning, RB distribution, MIMO information, and service requirement information, can be sent with the request. The request, including the parameters, is sent to the Analysis Function (AnF). In some embodiments, the D-Rep 1308 can subscribe to a PBD service with the parameters. At step 1330, the Analysis Function prepares a data collection request and sends the request to a Data Collection Function of the network. The data collection request can include parameters such as D-Rep IDs, corresponding to IDs of the D-Reps whose analysis and data will be collected in a suitable manner, Data Tags of the requested data and analysis, and Time Window, corresponding to an expected duration of the PBD and subscriptions, as well as, the past information that will be considered. The window begins from a specified time in the past and extends until the end of the PBD. Time window can be different for different types of data. For instance, channel sensing data may be selected from a recent data set while historical usage and mobility patterns of the UE can be used. The parameters can further include requested fidelity level for subscribed information, required synchronization precision, and Age-of-information requirements. At step 1332, the AnF can subscribe to a connection function in the network adapted to manage subscriptions to various data streams. For instance, the AnF can request the connection function to manage subscriptions to alerts, analysis and other data by sending a request with parameters that can include the PBD Zone, D-Rep IDs, Data Tags, Permission Level and Alert Permission, where the Permission Level defines a level of access to raw, filtered, analyzed, and anonymized data, and the Alert Permission defines access permission to alerts with analysis detail and timing detail. At step 1334, the connection function manages the subscription to other elements of the network, such as subscription to D-Reps 1312 included in the vulnerability region.

At step 1336, when the analysis function has performed the analysis or prediction, the analysis results are sent to the D-Rep 1308. For example, the PBD analysis results can include, for example, an Alert ID, a PBD zone, a PBD update frequency, a PBD risk level, a PBD subscription management, and twinning requirements. The Alert ID corresponds to the ID of the PBD alert for easy access and identification. The PBD zone corresponds to an updated more accurate vulnerability zone information which also includes D-Rep IDs and Physical entity IDs and expected updates, for instance. The PBD update frequency corresponds to an expected update frequency of the PBD analysis based on service type, mobility and channel conditions, for example. The PBD risk level corresponds to a risk of vulnerability in the PBD Zone. The PBD risk level can be generated as a single metric, a heat map of the grids in the vulnerability zone or any other suitable representation. The PBD subscription management is indicative of D-Reps and physical entities that are subscribed to the alerts and data updates. The twinning requirements are indicative of increasing fidelity level and changing the synch level, for instance.

At step 1338, the D-Rep 1308 of the BS 1304 distributes the relevant information, based on received information from the AnF, to other D-UEs and other D-Inf instances. Unless a blockage alert/prediction is generated, this process may continue with data collection and analysis.

### Example PBD Alert and Resolution

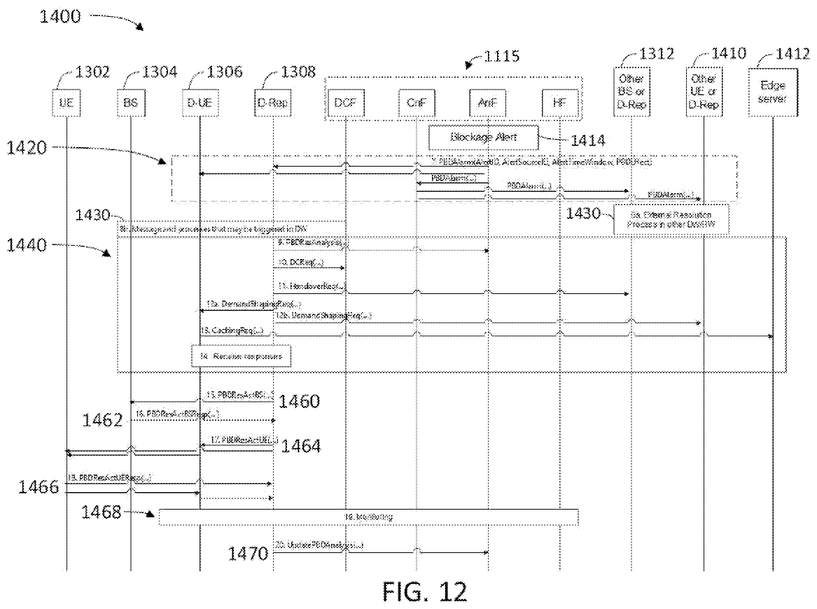

Turning to the embodiment shown in FIG. 12, a PDB and resolution process 1400 of alert and resolution is performed when a potential or future blockage is detected by the analysis function of the network at step 1414. At step 1420, upon predicting blockage, the AnF generates and sends it to the D-UE 1306 and or the D-Rep 1308. For example, the AnF sends the alarm to the D-Rep that has triggered the PBD. The alarm can include parameters such as Alert ID, Alert Source ID, Alert Time Window, PBD Effect, Vulnerable Grid ID and Broadcast List. The alarm can also be sent to the connection function (CnF) of the framework functions 1115 for broadcasting the alarm, for example to all DW and RW entities included in a vulnerability region. The alarm parameters transmitted can vary based on the receiving entity. For example, the D-rep 1308 may not need the broadcast list, and this parameter may only be sent to the connection function of the framework functions 1115.

In some embodiments, the analysis can be conducted by an algorithm included in a simulation library of the AnF and managed by the D-Rep requesting the PBD. Therefore, the AnF provides a direct communication between the simulation function and the D-Rep. When an alarm is generated, it is sent from the simulation function in the simulation library to the D-Rep 1308. In some embodiments, the analysis algorithm is hosted by a hosting function (HF) that may host the D-Reps and their data, while maintaining the D-Rep lifecycle. In this case, when an alarm is generated, it is not sent to the corresponding D-Rep, but instead the D-Rep may forward it to other related entities, such as other D-UEs, other D-Reps that are subscribed to the alarms, and alternatively the alarm is sent to the connection function to be broadcasted to subscribers. The parameters of the alarm can include an Alert ID indicative of the type of alert, a risk level, and other specific classes of the alert, for instance. The parameters of the alarm can also include Alert Source ID, which is indicative of the entity that triggered or caused the triggering of the alarm. In other words, Alert Source ID may indicate the analysis function that triggered the alarm, which is useful if multiple DWs exist, such as in a very large region. It may also indicate the entity that predicted blockage, such as another D-Rep that predicts blockage moving towards the selected vulnerability region, the potential blockage that sent its movement and/or associated predictions, or the vulnerable UE or its D-UE that had sent its mobility and/or associated predictions. Further, the Alert Source ID may indicate another PBD alarm that is received by another analysis function in a neighboring region, or another PBD alarm that is conducted for another UE in the same region, such as in case of per-UE analysis and when UEs vulnerability regions overlap.

The Alert Time Window parameter of the alert is indicative of a predicted blockage duration, such as long, short, or momentary, due to the mobility pattern of the blockage and/or vulnerable entities. The time window can depend on the vulnerable UE solely, such as when the UE is entering a tunnel, labelled as stationary potential blockage, with a certain speed. Alternatively, determining the time window can require considering relative mobility of the vulnerable UE with respect to the potential blockers. For example, if the communication channel of a UE is predicted to be blocked by a truck in traffic, determining the time window can include determining the movement of the UE relative to the truck. The PBD Effect parameter is indicative of the expected effect of the blockage. This can include complete loss of the link, minor obstruction, partial blockage, physical layer effects, such as shadowing. The Vulnerability Grid ID parameter is used when a grid-based blockage detection method is selected, and this parameter indicates the grid(s) that are vulnerable to the blockage.

Still at step 1420, the connection function broadcasts the alarm to subscribers and other entities that may be affected by the blockage. Subscribers can include other D-Reps located in the vulnerability region, for example. In some embodiments, the broadcasted alarm message triggers a resolution mechanism or process for the subscribers and entities receiving the alarm message. For example, regional PBD alarms can cause broadcasting to a large number of entities in both the real world and the digital world, leading to some of the entities to perform a resolution process, or resolution mechanism. The resolution process 1430 can be performed at an entity that belongs to another DW instance or a RW BS or UE outside the analysis region. Alternatively, the resolution process 1430 can be performed in the DW instance from which the analysis was triggered, and related RW entities. For example, the D-UE 1306 or D-Rep 1308 having received the PBD alarm can evaluate it and perform the resolution process 1430.

At step 1440, the D-Rep 1308 requests resolution analysis from the AnF by sending a PBDResAnalysis message to the AnF. Depending on the alarm ID, the D-Rep 1308 may conduct and send the resolution analysis request to the BS 1304 directly. The D-Rep 1308 can receive a resolution analysis response from the AnF containing actions for mitigating blockage effects. These can include updates for network resources, configurations, policies, beamforming updates, or handover, for instance. Alternatively, using the alarm ID, the D-Rep 1308 may determine that the issue can be solved by certain beamforming or scheduling methods. The resolution analysis results can be directly sent to the RW BS 1304. In some embodiments, the AnF or the entity that receives the analysis message can also send messages to an OAM, to request for changing network capacity or network slice capabilities. The PBDResAnalysis message includes parameters such as resolution action ID, resolution action parameter, and resolution action grids. The resolution action ID parameter is indicative of the type of resolution action, such as beamforming update, user-in-the-loop, or signal handover, for example. The resolution action parameter includes additional information related to the resolution action, including the IDs of the associated entities, such as BSs, UEs, RIS tile IDs, satellite IDs, or ITS vehicle IDs, for example. The resolution action grids is indicative of the grids that will be affected by the resolution action. Still at step 1440, the D-Rep 1308 can request additional information from a data collection function of the network, where the additional information may be helpful to determine the resolution strategy. The request can alternatively be triggered by the AnF.

The signal handover resolution mechanism can be requested by the D-Rep 1308. For instance, the D-Rep 1308 may request a virtual handover through the DW instance, which may trigger a real-world handover, if approved by the receiving BS or D-Rep.

The beamforming update can be requested to the D-Rep 1308 of a BS, or to any other D-Rep 1312, 1410 associated with a real-world entity capable of beamforming. The D-Rep 1308 can request the beamforming update using a DemandShapingReq request, where the request includes the UE that is vulnerable, and other UEs around the vulnerable UE, and other D-Reps associated with real-world entities such as cars, trucks, and robots, for instance. The DemandShapingReq request can include a number of parameters such as an area parameter, corresponding to a demand shaping area for spatial aspects including the area in which the demand shaping offers will be made, or in which the suggested changes on mobility of UEs will take effect. The parameters can also include a time interval parameter indicative of temporal aspects of the demand shaping, including delaying the traffic of some users or mobility of cars for instance, and a target cost parameter indicative of budget for demand shaping as a parameter for determining demand shaping specifics, and an offer parameter indicative of whether a specific offer is being made to the receiving entity.

In some embodiments, a CachingReq request is sent to edge servers 1412 to increase reliability of the network by caching, storing or duplicating, alert-related information or any other relevant information. The content can be determined by considering the specifics of the alarm, such as expected time of blockage, expected duration, expected location, affected UEs, or the physical layer effect, such as path loss or fading, for example. This can be particularly useful in a scenario where a wireless backhaul will be interrupted. The request can include parameters such as a Time Interval parameter, indicative of a time interval for which caching is required for PBD purposes, a content parameter corresponding to specific contents to be cached, and a location parameter indicative of a caching location. The location parameter may be changed to be another BS or edge server than the current one, when desired.

Once messages or requests have been sent according to steps 1430 and 1440, responses can be received, and various actions can be taken. For instance, a DemandShapingResp response includes information on the entities (e.g., IDs) that accept the offers, the entities that demand changes in offers, or the cost, for instance. Further, a HandoverResp response includes information whether the handover can be done, performance expectation for the vulnerable UE in case of handover, cost of the handover for the network, in terms of the performance degradation of other users for example, and similar information. This information can be further responded with the real handover request, or the handover can take place right away following a positive evaluation result, if the blockage is expected very soon. If the handover does not seem to provide the targeted performance, it does not take place. A CachingResp response includes information whether the request can be satisfied. If not, available memory, content, and time interval. may be shared. A DCResp response includes information on where the requested data is stored, the subscription information, and access or denial for data, for instance. A PBDResAnalysisResp response includes the resolution strategy. The response can include a variety of information to be evaluated by the D-Rep 1308 of the BS 1304, as well as solely including the modifications that should be performed by the D-Rep 1308 of the BS 1304.

Once the response is received at step 1440, step 1460 includes evaluating the responses and sending a resolution strategy to the BS 1304. The resolution response can be received by the D-Rep from the BS 1304, at step 1462, and can include parameters such as an Ack parameter, indicative of an acknowledgement of reception and approval, and a Change Request parameter, indicative of a request for changing parameters which include parameter indicator, and optionally values that may be suggested. For instance, MIMO updates including spatial and temporal aspects of beamforming, resource allocation policies and so on.

At step 1464, the resolution strategy can also be sent from the D-Rep 1308 to the D-UE 1306. The D-UE may alternatively create a resolution strategy and distribute it to the D-Rep 1308 and the real-world UE 1302. In some embodiments, the resolution can be sent by the D-UE 1306 or the D-Rep 1308 to the real-world UE 1302. At step 1466, the resolution response is sent by the real-world UE 1302 and can include parameters such as an Ack parameter, indicative of the Acknowledgement of reception and approval, and a Change Request parameter, indicative of a request for changing parameters which include parameter indicator, and optionally the values may be suggested.

Once resolution mechanisms are communicated and implemented, the process 1400 includes, at step 1468, monitoring the performance of the communication and how the resolution is applied, for instance. For example, the DW entities can continuously monitor the performance in view of the resolution mechanism used. At step 1470, based on the monitoring and the changing situations after the PBD alarm resolution, the D-Rep 1308 of the BS 1304 can request an update of the PBD Analysis.

### Example Risk Map

In some embodiments, when PBD analyses are performed, a risk map is generated or updated. The risk map is a time-space obstruction map which is updated periodically, such as every “T” seconds, and the map is used to predict obstructions in a geographical area associated with the risk map for the next T seconds. The risk map can be grid based and indicate the blockage risk of each grid. Different grids or sub-regions may have different PBD update frequencies. For instance, a risky grid, or a risky set of grids, such as a set of grids representing a sub-region, can be analyzed more frequently. The risk may be calculated based on criteria including available physical resources such as channel frequency, channel capacity, bandwidth, resource blocks, MIMO capability, power, and interference, BS and UE capabilities, services and/or demands from other UEs in the region, sensing data availability and accuracy, mobility of the vulnerable UE, mobility of blocking UEs, infrastructures and robots, and capacity and capabilities of other BSs in the vicinity of the grid.

Some parts of the PBD analysis performed by the AnF can be region based. For instance, the blockage risk of geographical grids may apply to all UEs included in those grids, and the PBD analysis can be performed on the region instead of duplicating analyses for UEs included in the grids. However, each UE has its own mobility, antenna, and services, and those factors may be considered for resolution of blockage effects. Alternatively, analysis may be conducted on a completely per-UE.

When the analysis is region-based, the blockage risk of geographical grids applies to all entities in the grid. In this case, no vulnerable UE is considered, and instead only blockers or potential blockers are identified. Resolution mechanisms and alarms may not be specific to the services or UEs. Further, UEs may need to subscribe to receive alarms, as the PBD analyses are not triggered by individual UEs. Depending on the mobility pattern, the subscription parameters may need to be updated frequently. When the analysis is conducted on a per-UE basis, the vulnerability region may be determined based on UE's movement and services. The PBD analyses are specific to a UE, and resolution actions or mechanisms can be taken in a timelier manner. As the PBD analyses are triggered by individual UEs, there is no need for subscribing to alarms. However, some analyses may be duplicated, as adjacent UEs or associated D-UEs may trigger a PBD analysis.

In some embodiments, hybrid analyses can be a mix of region-based and per-UE. In those cases, duplication can be prevented, and overall network performance can be increased, as PBD analyses are not generated only for specific UEs. There can be many vulnerability regions, corresponding to specific UEs. However, the regions also utilize grid-based analysis. For example, a UE-1 vulnerability region can include {G1:G10} grids, and UE-2 vulnerability region can include {G8:G13} grids.

As described above, PBD analyses can be triggered. For instance, a PBD analysis can be triggered when a UE sends a PBDAnalysisReq request to its associated D-UE, when a BS sends a PBDAnalysisReq request to its associated D-Rep, or when both the UE and the BS sends messages anytime during a sensitive communication including the UE and the BS, such as at the beginning or during establishment of the communication. The PBD analysis can alternatively be triggered by the D-UE and/or D-Rep themselves. For instance, the DW entities can receive data including sensitive communications and may start a PBD accordingly. The PBD analysis can also be triggered by a D-UE sending a PBDAnalysisReq request to a D-Rep (of BS) or vice versa, or by a D-UE (or D-Rep) requesting analysis from the Analysis Function (AnF). In this case, the AnF may forward the PBDAnalysisReq request to the D-Rep (or D-UE). The PBD analysis may further be triggered when a D-Rep or D-UE, not part of the sensitive communication, receives a PBDAnalysisReq request initiated by the AnF or the data collection function of the network, if the vulnerability region overlaps with their service/communication area. A PBD analysis can also be triggered when a predicted condition is different from an actual condition. For example, a PBD can be triggered when a channel condition prediction is different than actual channel information for a D-Rep or a D-UE.

Furthermore, PBD process or analysis can be triggered periodically, where the period may be determined based on the mobility of vulnerable UE, mobility of environmental objects, mobility of satellites and other access points. The PBD analysis can alternatively or additionally be trigger by a potential blockage-based trigger, for example if a potential blockage started moving or accelerating, or by service predictions, such as if another demanding service is predicted and it may cause interference or scarcity of resources. The PBD analysis can also be triggered by mobility of a vulnerable UE, or by an unexpected change in channel sensing due to weather, or a different kind of blockage, for instance.

### Example D-Inf and Framework Functions

As described above, the predictive blockage detection can be performed using a D-Inf 1110 which includes a plurality of D-Reps, and framework functions 1115 adapted to provide a number of functionalities to the D-Reps. In some embodiments, the framework functions 1115 includes the connection function (CnF), the data collection (DC) function, the hosting function, and the analysis function.

### Data Collection (DC) Function

The DC function, module, or service provides services for collecting data from D-Reps, real-world objects, or other D-Inf, for example. The DC function provides data-collection-related services. For example, the DC function is adapted to perform resource allocation for data collection services. The DC function can also prepare data collection mission tables and/or coordinate with a Mission Manager. In the present application, a data collection mission can refer to a set of sequential steps to be performed by one or more of the framework functions to collect data from one or more sources, connect to D-Reps, and perform data analysis, for instance.

The DC function is further responsible for performing network-wide configurations to facilitate performing data collection services. The DC function can be operatively connected and cooperating with the Connection Function for configuration purposes. For instance, the DC function may prepare part of the configurations or requirements needed for data collection services and implement them via the Connection function, or other connectivity-as-a-service providers, such as connectivity networks (CONET) or connection managers (CM). Performing the network-wide configurations can include, without being limited to, activating/deactivating pre-filtering of data to be collected, and configuring pre-filter parameters. Exemplary pre-filter parameters can include pre-filtering on/off periodicity, pre-filtering triggers, pre-filtering range to omit, and pre-filtering grids. A pre-filtering range to omit refers physical or logical range, such as a geographical distance range, within which data is to be omitted. For example, data associated with real-world objects located in a given range from a location are to be omitted, or not collected. For example, any data associated with real-world objects in a range of 5 m, 10 m, or 100 m from a given real-world object are to be omitted. A pre-filtering grid can be used when a geographical region has grid-based approximations, analyses or predictions. In such cases, the grids can be used to filter out data in a more precise manner compared to range-based methods. Performing network-wide configurations can also include configuring and/or determining sensor battery level and expected life-based data collection configuration, e.g., frequency, buffering, number of hops, acceptable age, synchronization requirements. For example, the DC function can monitor battery life of sensors used to collect the real-world data from the real-world objects. In some embodiments, the DC function can further provide data discovery services for existing digital-world entities, allowing to obtain services from other entities or platforms on the network by connecting to other gateways for instance. The DC function can also monitor real-world objects, for instance via their respective sensors, to determine if new real-world data is available. The DC function further provides data collection services including preparing tags, labels, location identification (ID) and other aspects of data to be retrieved, together with preventing data collection redundancies, if applicable, and applying pre-filtering to data collection.

As described above, data pre-filtering can be applied to data collection based on pre-filtering parameters. Considering the large amount of data that may be collected for/by D-Reps and D-Inf, for example when performing predictive blockage detection over a large geographical area, it can become necessary or relevant to ensure that data collection is efficient, as to not overload the network or a node of the network. Some data may not be useful/viable due to low quality, duplicates from nearby real-world sensors and other purposes. Further, some data may be irrelevant or non-urgent. Similarly, some data may particularly relevant and urgent for a given application, such as for a given simulation to be performed by the D-Inf. In such cases, pre-filtering allows to classify the data before it uses bandwidth and processing resources of the network. Filtering the data can include merging similar, non-urgent data (buffer-like), cleaning noisy data to reduce size, discarding faulty data, sampling redundant data, labeling and tunneling urgent data, and processing urgent data.

### Connection Function

The Connection function, module, or service is responsible for providing connectivity between D-Reps of the D-Inf, and to D-Reps outside the D-Inf, such as if a predictive blockage detection needs that from a D-Reps outside the D-Inf. The connectivity can be needed for a variety of purposes including data collection, network services, accessing to third-party services, and accessing to D-Reps within and outside of the D-Inf platform. In order to provide connectivity, the connection function cooperates with other functions of the D-Inf, such as the DC function. For instance, the connection function can provide Connectivity Manager (CM)-as-a-service. The connection function can also provide connection missions or mission maps in coordination with other functions. Connection missions can refer to a set of steps for connecting various elements of the D-Inf and/or external elements to the D-Inf. For instance, when there is a need for an analysis that cannot be performed with the current simulation environment through the analysis function a service request is transmitted to connection function. For instance, if a predictive algorithm is not available, a connection mission can be set up to retrieve the algorithm from another D-Inf or network. The connection function can produce the related mission map and communicate with other network service providers to execute the mission map.

The connection function further performs resource allocation for connectivity requirements of D-Reps, including D-Rep mobility management. D-Rep mobility management can be used when, for instance, a D-Rep being stored at an edge server connects with a main D-Rep in the cloud and may need to be migrated from one server to another to lower needed bandwidth, for instance. Migration may depend on the real-world device mobility, network congestion, server availability, location where most data is sensed for the D-Rep, that can differ from the location of the RW device, and delay/latency criteria, for example. In some cases, the Connectivity Manager of the networks can assist in D-Rep mobility management with regards to real-world device mobility management. The CM can trigger the D-Rep migration.

The connection function is further adapted to set up connectivity tunnels for external simulation environment, provide connectivity within the D-Inf platform if the platform is built in a multi-cloud way for instance, or includes edge components. The connection function also provides an authentication function that can be useful in a variety of scenarios and interfaces. For example, using a D-Rep-sensor connectivity, the connection function can perform authentication of the sensor and the data from the sensor. The connection function can also provide authentication functionalities with a D-Rep-Edge twin connectivity, to authenticate the edge twin and the cloud twins for data exchange. The authentication function may also be used with D-Rep-actuator connectivity, to authenticate the D-Rep before the actuator can perform the requested action. As another example, the authentication function can further be used for Crowd sensing user authentication, for data labelling. The connection function further prepares/assists in-network data processing missions from the processing aspects of the mission. The connection function can also enable processing in-network data, including the distribution of processing algorithms.

### Hosting Function

The hosting function, module, or service level aspects of hosting D-Reps, such as resource allocation for data storage, and provides security for D-Rep data storage. For instance, the hosting function is adapted to perform D-Rep lifecycle management in coordination with other functions and services, where lifecycle management can include request resource allocation and deallocation, and raising alarms, for example. Further, the hosting function provides asset management functionality, including maintaining, in real-time, multiple physical entities that are a part of a same D-Rep.

In some embodiments, the hosting function also provides D-Rep association management. For instance, a certain D-Rep can comprise other D-Reps instead of being associated with one or more real-world entities or objects. In this case, the one or more D-Reps can be associated to establish a “master D-Rep”. For example, an RIS may consist of tiles and controllers. The tile D-Reps must be associated with the controller D-Rep to represent the RIS D-Rep.

In preferred embodiments, the hosting function further provides D-Rep maintenance functionality. In collaboration with the analysis function, the maintenance functionality allows the hosting function to verify the health of D-Reps. The health of a D-Rep may be defined in terms of accuracy, resource utilization efficiency, for example. D-Rep maintenance functionality also includes predicting the resource requirements for a given D-Rep and ensuring service continuity. The hosting function is also responsible for raising alarms if the D-Rep health deteriorates. D-Rep health and accuracy measurements can include fidelity, and the fidelity of the D-Rep can be optimized to minimize costs while maximizing benefits. Health checks are discussed more detailed later.

Through the Data plane, the hosting function provides data storage functions allowing to choose between types of storage, such as private storage or common storage options for certain data. If the data is to be stored privately, it may not be processed by the network and storage functions merely verify maintenance of the private storage. If the data is to be stored in common storage, the data storage functions arrange anonymization and labelling to prepare data for common storage. Once the data is ready, it is stored in a determined location. The storage location can depend on where the data is collected from, where the D-Reps that may need this data are located, which applications use this data, and sensitivity of data, such as low-latency or high priority, for instance. Multiple copies of the data can be generated by the data storage function, such as to be stored at an edge server, in different geographical regions, areas, networks, clouds, or data lakes, for example.

### Analysis Function

The analysis function, module, or service is adapted to provide analysis tasks of D-Reps. The analysis function can collaborate with the connection function for internal and external connectivity requirements. For instance, the analysis function can determine the connectivity requirements for performing an analysis or predictive detection, and perform resource management for computation and storage requirements for performing the simulations or analyses. The analysis function can also perform optimization for a simulation environment operation. Further, the analysis function provides simulation functionality by enabling simulation services, organizing access to the simulation library and helping to maintain simulation library.

The analysis function can also provide abstraction levels. For instance, specialized D-Inf platforms, or sub-platforms, such as a D-NET sub-platform, can be implemented. A different application, or sub-platform, may need different D-Reps. For example, D-NET for optimization and D-NET for asset management may have different characteristics. Configuring the D-Inf can be performed by the analysis function.

Further, the analysis function provides analysis services. Depending on the data, computation resources and the architecture of the D-Rep and D-Inf sub-platform, the simulations may run in the network or via a third party such as by downloading a local copy/image of the simulator. Additionally, the analysis function provides a benchmark library. These benchmark methods of the library are used to test the performance/monitoring of D-Rep and D-Inf sub-platforms. The analysis function also provides a labelling function. Depending on applications, data labelling can be important, but also difficult and expensive. Wireless networks can make a difference if they are allowed to process the data in network and label it. Several methods of labelling can be used by the analysis function, such as automated labelling with the help of classification algorithms, distributed learning, and crowd sourcing labelling, including communicating with wireless network users, application providers to label the data. The analysis function also provides the platform for crowd-sourcing-based labelling.

The analysis function can also provide an anonymization service, including anonymizing data for storage, in-network processing, and labelling, for instance. In some embodiments, the analysis function can also provide method optimization and algorithm selection services. For example, a sub-platform-1 can utilize method-1 for service-1, and sub-platform-2 can utilize method-2 for service-1. If method-1 provides better performance, such as in terms of accuracy, computational efficiency, or data efficiency, the analysis function can suggest method-1 to sub-platform-2. In order to provide this service, the analysis function requests the DC function to collect performance information of methods used for similar services.

The embodiments as described above may provide features and benefits such as increasing communication reliability by preventing link interruptions, allowing effective data transfer and actuation for blockage detection remedies, providing access to data, preventing data collection redundancies, alerting real-world entities, and further allows for virtual event triggers and double verification of alerts. Further, some embodiments provide a risk map that can be a time-space representation of obstructions that takes advantage of grid-based methods.

In addition, embodiments of the disclosure are not limited to 6G but any kind of technology that uses wireless links for communication. For instance, the method and system described herein are applicable to Wi-Fi as well. For example, the method and system may be implemented in a mall where people may act as blockage to each other at high communication frequencies. In such a scenario, D-Reps of UEs may be used to track mobility patterns, such as speed and direction, and alert another UE that may be affected.

One or more systems (or modules) described herein may be implemented in computer programs executing on processing devices, each comprising at least one processor, a data storage system (including volatile and non-volatile memory and/or storage elements), at least one input device, and at least one output device. The term “processing device” encompasses computers, servers and/or specialized electronic devices which receive, process and/or transmit data. “Processing devices” are generally part of “systems” and include processing means, such as microcontrollers and/or microprocessors, CPUs or are implemented on FPGAs, as examples only. For example, and without limitation, the processing device may be a programmable logic unit, a mainframe computer, server, a personal computer, a cloud-based program or system, a laptop, a personal data assistance, a smartphone, a wearable device, or a tablet device.

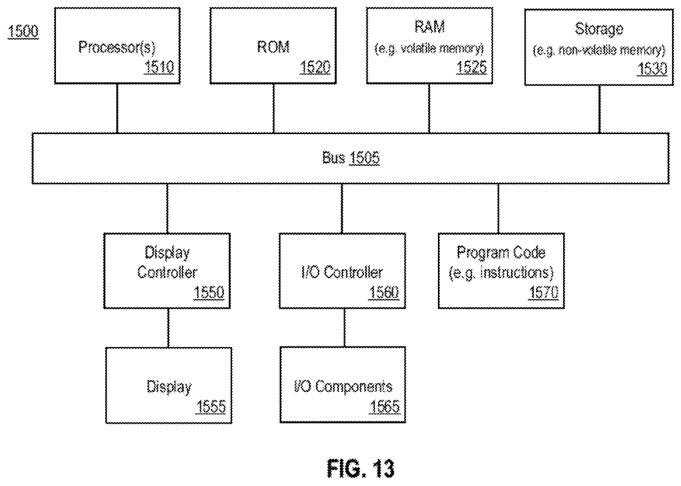

FIG. 13 shows a block diagram of an example computing system that may be used in conjunction with one or more embodiments of the disclosure. For example, system 1500 (or computing system, or server, or computing/electronic device, or device) may represent any of the devices or systems described herein that perform any of the processes, operations, or methods of the present disclosure. Note that while the computing system 1500 illustrates various components, it is not intended to represent any particular architecture or manner of interconnecting the components as such details are not germane to the present disclosure. It will also be appreciated that other types of systems that have fewer or more components than shown may also be used with the present disclosure.

As shown, the system 1500 may include a bus 1505 which may be coupled to a processor 1510, ROM (Read Only Memory) 1520, RAM (or volatile memory) 1525, and storage (or non-volatile memory) 1530. The processor(s) 1510 may retrieve stored instructions from one or more of the memories 1520, 1525, and 1530 and execute the instructions to perform processes, operations, or methods described herein. These memories represent examples of a non-transitory computer-readable medium (or machine-readable medium, a computer program product, etc.) containing instructions (or program code) which when executed by a processor (or system, device, etc.), cause the processor to perform operations, processes, or methods described herein.

As referred to herein, for example, with reference to the claims, a processor may include one or more processors. Moreover, the one or more processors 1510 may perform operations in an on-demand or “cloud computing” or “software-as-a-service” (SaaS) implementation. Accordingly, the performance of operations may be distributed among the one or more processors 1510, whether residing only within a single machine or deployed across a number of machines. For example, the one or more processors 1510 may be located in a single geographic location, or may be distributed across a number of geographic locations. The RAM 1525 may be implemented as, for example, dynamic RAM (DRAM), or other types of memory that require power continually in order to refresh or maintain the data in the memory. Storage 1530 may include, for example, magnetic, semiconductor, tape, optical, removable, non-removable, and other types of storage that maintain data even after power is removed from the system. It should be appreciated that storage 1530 may be remote from the system (e.g. accessible via a network).

A display controller 1550 may be coupled to the bus 1505 in order to receive display data to be displayed on a display device 1555, which can display any one of the user interface features or embodiments described herein and may be a local or a remote display device. The computing system 1500 may also include one or more input/output (I/O) components 1565 including mice, keyboards, touch screen, network interfaces, printers, speakers, and other devices. Typically, the input/output components 1565 are coupled to the system through an input/output controller 1560.

Program code 1570 may represent any of the instructions, applications, software, libraries, toolkits, modules, components, engines, units, functions, logic, etc. as described herein. Program code 1570 may reside, completely or at least partially, within the memories described herein (e.g. non-transitory computer-readable media), or within a processor during execution thereof by the computing system. Program code 1570 may include both machine code, such as produced by a compiler, and files containing higher-level or intermediate code that may be executed by a computing system or other data processing apparatus (or machine) using an interpreter. In addition, program code 1570 can be implemented as software, firmware, or functional circuitry within the computing system, or as combinations thereof. Program code 1570 may also be downloaded, in whole or in part, through the use of a software development kit or toolkit that enables the creation and implementation of the described embodiments.

Moreover, any of the disclosed embodiments may be embodied in various types of hardware, software, firmware, and combinations thereof. For example, some techniques disclosed herein may be implemented, at least in part, by non-transitory computer-readable media that include program instructions, state information, etc., for performing various methods and operations described herein. The computer-readable storage medium may be any tangible non-transitory medium such as optical (e.g., CD, DVD, Blu-Ray, etc.), magnetic, hard disk, volatile or non-volatile, solid state, or any other type of storage medium known in the art.

The terms “a”, “an” and “one” are defined herein to mean “at least one”, that is, these terms do not exclude a plural number of items, unless stated otherwise. In the present disclosure, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

Terms such as “substantially”, “generally” and “about”, which modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

Expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present description, the expression “based on” is intended to mean “based at least partly on”, unless specified otherwise (e.g. “based solely on”). More particularly, the expression “based on” could also be understood as meaning “depending on”, “representative of”, “indicative of”, “associated with” or similar expressions.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

What is claimed is:

1. A method, comprising:
receiving a request for performing predictive blockage detection within a vulnerability region covered by the wireless network, a detected predictive blockage being indicative of a future signal degradation in the vulnerability region;
retrieving entity data associated with one or more digital representatives (D-Reps), the one or more D-Reps corresponding to digital replicates of real-world entities, and the entity data comprising real-world data collected from the real-world entities;
performing the predictive blockage detection based on the entity data; and
transmitting a blockage alert when a blockage is predicted.

2. The method according to claim 1, wherein:
the request for predictive blockage detection is transmitted by a first D-Rep;
the vulnerability region is a geographical region in which a first entity associated with the first D-Rep is located or moving towards; and
the alert is transmitted to one of the first D-Rep and the first entity.

3. The method according to claim 2, wherein the first entity is a user equipment (UE) served by the wireless network, the first D-Rep is a digital replicate of the UE, and the vulnerability region is based on movement of the UE.

4. The method according to claim 2, wherein the first entity is a base station (BS), wherein the first D-Rep is a digital replicate of the BS, and wherein the vulnerability region is based on a location of the BS.

5. The method according to claim 1, wherein the vulnerability region includes vulnerable network entities, and wherein transmitting the blockage alert comprises transmitting the blockage alert to D-Reps associated with the vulnerable network entities.

6. The method according to claim 1, further comprising:
generating a risk map of an area including a plurality of vulnerability regions; and
updating a given vulnerability region of the risk map when an associated predictive blockage detection is performed.

7. The method according to claim 6, wherein updating the given vulnerability region comprises determining a blockage risk based on performing the predictive blockage detection in the vulnerability region.

8. The method of claim 7, wherein the blockage risk is further determined based on available physical resources within the vulnerability region.

9. The method according to claim 1, wherein the request for predictive blockage detection includes predictive blockage detection parameters with a list of D-Reps located in the vulnerability region, and wherein retrieving the entity data comprises connecting with nodes of the wireless network hosting the D-Reps located in the vulnerability region based on the predictive blockage detection parameters.

10. The method according to claim 1, further comprising:
when a blockage is predicted, generating a resolution mechanism to be performed by a target network entity to prevent blockage.

11. The method according to claim 1, wherein performing the predictive blockage detection comprises predicting future locations of the real-world entities associated with the one or more D-Reps and determining whether an obstructing network entity is predicted to obstruct a signal on the wireless network at one of the future locations.

12. The method according to claim 1, further comprising storing the one or more D-Reps on a wireless network.

13. The method according to claim 1, wherein performing the predictive blockage detection comprises performing the predictive blockage detection by an analysis function instantiated on a node of a wireless network.

14. The method according to claim 1, wherein transmitting the blockage alert comprises transmitting the blockage alert to a plurality of D-Reps located within the vulnerability region.

15. The method according to claim 1, wherein transmitting the blockage alert comprises transmitting the blockage alert to a plurality of the real-world entities located within the vulnerability region.

16. The method according to claim 1, wherein transmitting the blockage alert includes transmitting an alert time window indicative of blockage duration.

17. The method according to claim 1, further comprising:
subscribing, by a D-Rep, to blockage alerts; and
wherein transmitting the blockage alert comprises:
transmitting the blockage alert to a registered D-Rep.

18. An apparatus, comprising:
at least one processor;
a memory storing executable instructions that are executed by the at least one processor, the executable instructions comprising instructions to:
receive a request for performing predictive blockage detection within a vulnerability region covered by the wireless network, a detected predictive blockage being indicative of a future signal degradation in the vulnerability region;
retrieve entity data associated with one or more digital representatives (D-Reps), the one or more D-Reps corresponding to digital replicates of real-world entities, the entity data comprising real-world data collected from the real-world entities;
perform the predictive blockage detection based on the entity data; and
transmit a blockage alert when a blockage is predicted.

19. The apparatus of claim 18, wherein the instructions further comprise instructions to:
generate a resolution mechanism to be performed by a target network entity to prevent blockage, when a blockage is predicted.

20. A computer-readable medium having computer-readable instructions stored thereon that, when executed by one or more processors, cause a device to:
receive a request for performing predictive blockage detection within a vulnerability region covered by the wireless network, a detected predictive blockage being indicative of a future signal degradation in the vulnerability region;
retrieving entity data associated with one or more digital representatives (D-Reps), the one or more D-Reps corresponding to digital replicates of real-world entities, the entity data comprising real-world data collected from the real-world entities;
performing the predictive blockage detection based on the entity data; and
transmitting a blockage alert when a blockage is predicted.
